(19) United States
(12) Patent Application Publication
(10) Pub. No.: US 2007/0178401 A1
(43) Pub. Date: Aug. 2, 2007

(54) Method of producing polymerized toner

(75) Inventor: Hisashi Kurokawa, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, Tokyo (JP)

(21) Appl. No.: 11/699,394

(22) Filed: Jan. 30, 2007

(30) Foreign Application Priority Data
Jan. 31, 2006 (JP) 2006-023974

(51) Int. Cl. G03G 9/08

(52) U.S. Cl. 430/137.17; 430/137.15

(57) ABSTRACT

The present invention provides a method of producing a polymerized toner which is capable of dispersing a colorant in a polymerizable monomer finely and uniformly and is excellent in production efficiency, wherein a step of preparing a polymerizable monomer composition containing the polymerizable monomer and the colorant includes a dispersing process in which a polymerizable monomer mixture containing the polymerizable monomer and the colorant is supplied to a media type dispersing machine equipped with a media particle and a screen for media separation and the colorant is dispersed in the polymerizable monomer mixture to obtain a polymerizable monomer dispersion,
wherein a media diameter of the media particle and an aperture ratio of the screen for media separation satisfy the following formulas 1 and 2:

$$\begin{matrix}Formula 1 \text{:} & \\ 0.01 mm \leq ( media diameter ) \leq 0.3 mm & \\ Formula 2 : & \\ 50 \leq \frac{( Aperture ratio )}{( Media diameter )} \leq 260 & \end{matrix}$$

wherein, in the Formula 2, the aperture ratio is a value expressed in percentage and the media diameter is a value expressed in millimeter.

### BACKGROUND OF THE INVENTION

1. Field of the Invention

The present invention relates to a method of producing a polymerized toner for developing a latent image of electrostatics or the like by an electrophotography, an electrostatic recording method, an electrostatic printing process or the like. Hereinafter, “a polymerized toner” may be simply referred to as “a toner”.

2. Description of the Related Art

A method of forming desired images by developing an electrostatic image with a polymerized toner is widely used. For example, in an electrophotography, a latent image of electrostatics formed on a photosensitive member is developed by a toner comprising a colored resin particle and, if required, other particles such as an external additive, a carrier or the like so as to obtain a toner image, and the toner image is transferred to a transferring material such as paper, an OHP sheet or the like. Then, the toner image is fixed on the transferring material, and thus obtained a printed product.

Methods of producing a colored resin particle, which is a main component of a toner, are broadly classified into a dry method or a wet method.

As the dry method, there may be a pulverizing method, wherein a solid of a colored resin, which is obtained by dissolving, mixing and kneading a binder resin and a colorant, is pulverized and classified so as to produce a colored resin particle.

As the wet method, on the other hand, there may be a polymerization method or a solution suspension method, wherein the methods comprise a process to form a droplet of a colored resin particle in an aqueous dispersion medium.

As the polymerization method, for example, there may be a suspension polymerization method, wherein a droplet of a polymerizable monomer composition containing a polymerizable monomer and a colorant is formed by dispersing the polymerizable monomer composition in an aqueous dispersion medium and is polymerized so as to produce a colored resin particle, an emulsion polymerization agglomeration method, wherein a colored resin particle is produced by aggregating a microparticle of a resin, which is obtained by polymerizing an emulsified polymerizable monomer, with a colorant and so on, or the like.

Also, the solution suspension method is a method of producing a colored resin particle by dispersing a solution comprising an organic solvent, wherein toner components such as a binder resin, a colorant and soon are dissolved or dispersed, in an aqueous dispersion medium to form a droplet and removing the organic solvent.

To obtain a high-resolution image using a toner produced by the polymerization method (it may be referred to as “a polymerized toner”), a colorant is required to be dispersed in the polymerized toner finely and uniformly. Hence, in the case of producing a polymerized toner by the suspension polymerization method, a colorant is firstly required to be dispersed in a polymerizable monomer finely in the step of preparing a polymerizable monomer composition containing the polymerizable monomer and the colorant. As the colorant, a substantially insoluble pigment or dye powder is generally used with a liquid polymerizable monomer. However, the colorant is not pulverized enough usually. In addition, it is difficult to disperse the colorant in the polymerizable monomer uniformly.

If dispersion of the colorant in the polymerizable monomer composition is insufficient, distribution of particle diameter of the colorant enlarges and a colorant which is large in particle diameter increases. Hence, in the step of forming a droplet of the polymerizable monomer composition by dispersing the polymerizable monomer composition in an aqueous dispersion medium, forming a droplet of the uniformly-dispersed polymerizable monomer composition in an aqueous dispersion medium becomes difficult. Therefore, distribution of particle diameter of the polymerized toner becomes broad or obtaining image quality is likely to be lowered. Further, if the colorant is not dispersed finely and uniformly, storage stability of the polymerizable monomer composition after dispersion may decrease and a colorant held in storage is likely to separate.

As a method of dispersing a colorant in a polymerizable monomer composition, a method using one of various media type dispersing machines has been proposed. For instance, Japanese Patent Application laid-open (JP-A) No. Hei. 6(1994)-75429 discloses a method of producing a polymerized toner by means of a media type dispersing machine shown in FIG. 5 in the process of dispersing a colorant in a polymerizable monomer composition.

The media type dispersing machine shown in FIG. 5 has a structure that plural agitator disks (more specifically, “rotors”) 507 disposed on a drive shaft 510 are arranged in a cylindrical casing 501 having a liquid inlet 502 and media particles 508 in large quantity are provided in the space inside the cylindrical casing 501. A mixture containing a finely-dispersed colorant is separated from the media particle by a media separating gap separator 509.

Since the space inside the media type dispersing machine of JP-A No. Hei. 6(1994)-75429 shown in FIG. 5 is large, when raising a peripheral speed at the edge of the agitator disks to increase ability to pulverize the colorant, a packing phenomenon appears prominently and media particles in the machine are distributed unevenly. The packing phenomenon is a phenomenon wherein media particles filled inside of the media type dispersing machine are pressed against the inside surface of the casing by centrifugal force of the agitator disk. As a result, there is a problem that the mixture is likely to move only through parts with less media particles, in other words, a short path may occur, and efficiency and uniformity of dispersion may lower. Since media particles are likely to be unevenly distributed around the media separating gap separator, there are additional problems that pressure in the machine may increase and dispersion efficiency may lower.

In JP-A No. 2005-77729, a media type dispersing machine provided with a screen for media separation is disclosed. As shown in FIG. 3, the media type dispersing machine 301 disclosed in JP-A No. 2005-77729 has a structure that a rotor 316, which is capable of rotating as a drive shaft 319 rotates, and a screen for media separation 318 are provided in a casing 302.

A polymerizable monomer mixture containing a polymerizable monomer and a colorant, which is continuously supplied into the casing 302 from a line 314 and through a liquid inlet 303, is subject to be under strong shearing stress due to centrifugal force generated by rotation of the rotor 316 and an action of a media particle 317. Thereby, the colorant can be finely dispersed in the polymerizable monomer mixture.

Generally, from the viewpoint of dispersibility of a colorant in a polymerizable monomer mixture, a distance between media particles can be narrowed as a particle diameter of a media particle decreases. Accordingly, media particles used in a media type dispersing machine can disperse the colorant very finely. A media type dispersing machine provided with a screen for media separation as disclosed in JP-A No. 2005-77729 is excellent in separating the media particle and the polymerizable monomer mixture. Hence, in the media type dispersing machine, media particles having a smaller particle diameter than conventionally-used particles can be used and hardly causes uneven distribution of media particles compared to the media type dispersing machine disclosed in JP-A No. Hei. 6(1994)-75429. Therefore, a colorant can be dispersed finely in a polymerizable monomer.

### SUMMARY OF THE INVENTION

As described above, a media type dispersing machine provided with a screen for media separation can finely disperse a colorant in a polymerizable monomer by means of a media particle which is small in particle diameter. When using the media particle which is small in particle diameter, however, to separate the media particle, an aperture size of the screen for media separation is required to be narrowed. Hence, depending on the colorant subject to dispersion, choking at the screen for media separation may easily occur. As a result, speed of dispersion treatment may lower and production efficiency may substantially decrease. In the severe case, the screen for media separation may be choked and fail in dispersion treatment completely.

The present invention has been achieved in light of these circumstances. An object of the present invention is to provide a method of producing a polymerized toner which is capable of dispersing a colorant in polymerizable monomer finely and uniformly and is excellent in production efficiency.

As the result of diligent researches made to attain the above object, the inventor of the present invention focused on the relationship between a media diameter and an aperture ratio of a screen for media separation when finely and evenly dispersing a colorant in polymerizable monomer by means of a media type dispersing machine provided with a screen for media separation and a media particle which is small in particle diameter and found out that by choosing a screen for media separation having a suitable aperture ratio corresponding to a specific media diameter, choking of the screen for media separation can be reduced even in the case of using a media particle which is small in particle diameter.

More specifically, the present invention has been achieved based on the finding and is a method of producing a polymerized toner comprising the steps of:

(1) preparing a polymerizable monomer composition containing a polymerizable monomer and a colorant;

(2) forming a droplet of the polymerizable monomer composition by dispersing the polymerizable monomer composition in an aqueous dispersion medium; and

(3) forming a colored resin particle by polymerizing the droplet of the polymerizable monomer composition,

wherein the step (1) includes a dispersing process in which a polymerizable monomer mixture containing the polymerizable monomer and the colorant is supplied to a media type dispersing machine equipped with a media particle and a screen for media separation and the colorant is dispersed in the polymerizable monomer mixture to obtain a polymerizable monomer dispersion, and

wherein a media diameter of the media particle and an aperture ratio of the screen for media separation satisfy the following formulas 1 and 2:

$$\begin{matrix}Formula 1 \text{:} & \\ 0.01 mm \leq ( media diameter ) \leq 0.3 mm & \\ Formula 2 : & \\ 50 \leq \frac{( Aperture ratio )}{( Media diameter )} \leq 260 & \end{matrix}$$

wherein, in the Formula 2, the aperture ratio is a value expressed in percentage and the media diameter is a value expressed in millimeter.

In order to perform fine dispersion treatment efficiently, in the step (1), it is preferable that the polymerizable monomer mixture is subject to preliminary dispersion and an obtained preliminarily-dispersed polymerizable monomer mixture is supplied to the media type dispersing machine so as to be dispersed.

Particularly, in the case that the polymerizable monomer mixture contains a colorant having a volume average particle diameter of 20 μm or more and/or a colorant which has a volume percentage (D₅₁) of a particle having a particle diameter of 51 μm or more by 20% or more, it is highly effective to perform the preliminary dispersion before the dispersion treatment by means of the media type dispersing machine in order to prevent choking at the screen for media separation.

In order to disperse the colorant finely and uniformly, it is preferable that, in the step (1), after the polymerizable monomer mixture comprising the polymerizable monomer and the colorant is subject to preliminary dispersion and an obtained preliminarily-dispersed polymerizable monomer mixture is supplied to the media type dispersing machine for dispersion, other components required for the toner are added to the obtained polymerizable monomer dispersion.

A method of the preliminary dispersion can be a method using a preliminary dispersing machine beside the method using the media type dispersing machine equipped with the screen for media separation. The preliminary dispersion can be performed by applying mechanical shearing stress to the colorant in the polymerizable monomer mixture. It is preferable that a peripheral speed at the edge of a stirring vane of the preliminary dispersing machine is from 15 to 60 m/s.

When dispersing preliminarily, in order to prevent cavitation due to high-speed stirring, it is preferable that an inner pressure of the preliminary dispersing machine is in the range of 0.01 to 15 MPa.

In order to prevent temperature of the polymerizable monomer mixture (liquid temperature) rising due to heat by shear, it is desirable that the preliminary dispersion is performed while holding a temperature variation range of the polymerizable monomer mixture before and after the preliminary dispersion preferably at 30° C. or less.

After the preliminary dispersion, it is preferable that a volume average particle diameter of the colorant of the preliminarily-dispersed polymerizable monomer mixture is less than 20 μm and a volume percentage (D₅₁) of a particle having a particle diameter of 51 μm or more of the colorant of the preliminarily-dispersed polymerizable monomer mixture is less than 20%.

In the process of dispersion, it is preferable that the polymerizable monomer mixture or the preliminarily-dispersed polymerizable monomer mixture is supplied to the media type dispersing machine to disperse the colorant, discharged from the media type dispersing machine, supplied again to the media type dispersing machine, and continuously circulated at a circulation number of two or more.

Also, it is preferable that a ratio of a volume of the media particle with respect to an inner volume of the media type dispersing machine where the media particle is present is from 60 to 95 volume percent.

It is preferable that a viscosity of a polymerizable monomer dispersion to be obtained by the process of dispersion is from 300 to 2,500 cP.

A colorant dispersing agent may be added to the polymerizable monomer mixture in the step (1) to stabilize a dispersion state of the colorant. The colorant dispersing agent may be selected from the group consisting of an Al coupling agent, a silane coupling agent and a titanate coupling agent. In order to perform a uniform dispersion efficiently in the step (1), it is preferable that the polymerizable monomer mixture with the colorant dispersing agent added is subject to preliminary dispersion and an obtained preliminarily-dispersed polymerizable monomer mixture is supplied to the media type dispersing machine

Since partial polymerization is likely to start under high temperature, it is desirable that the liquid temperature of the polymerizable monomer mixture or the polymerizable monomer dispersion is in the range of 10 to 30° C. in the step (1).

In the present invention, a media diameter of the media particle may be preferably 0.01 mm or more and 0.1 mm or less in the process of dispersion. Also, in the process of dispersion, the screen for media separation can be a notch wire type or a wedge wire type cylindrical screen. A rotor and a casing of the media type dispersing machine, which contacts with the polymerizable monomer mixture or the polymerizable monomer dispersion, can be made of a material having Rockwell Hardness C-Scale (HRC) of 20 or more.

According to the above-described method of producing a polymerized toner of the present invention, since a media particle having a small particle diameter is used for a media type dispersing machine equipped with a screen for media separation, a colorant can be dispersed in a polymerizable monomer finely and uniformly and a polymerized toner capable of providing a high-resolution image can be produced. In addition, choking of the screen for media separation may not occur in spite of using the media particles having a small particle diameter, thus, productivity of the polymerized toner can be high.

### BRIEF DESCRIPTION OF THE DRAWINGS

In the accompanying drawings,

FIG. 1 is an explanatory diagram showing a preliminary dispersion system employed in examples of the present invention;

FIG. 2 is an explanatory diagram showing a dispersion system employed in examples of the present invention;

FIG. 3 is a sectional view showing an example of a media type dispersing machine equipped with a screen for media separation used in the present invention;

FIG. 4 is an explanatory diagram showing a rotor used in a media type dispersing machine equipped with a screen for media separation used in the present invention;

FIG. 5 is a sectional view showing an example of a conventional media type dispersing machine;

FIG. 6 is a side view of one constitutional example of a notch wire type screen (partially omitted); and

FIG. 7 is a partially enlarged view of an element surface shown in FIG. 6.

The sign in each figure refers to the following: 101: a holding tank; 102: a stirring vane; 103: a stirring motor; 104: a jacket; 105: a temperature controlling medium inlet; 106: a temperature controlling medium outlet; 107: a circulating line; 108: a pump; 109: a preliminary dispersing machine; 110: a motor; 111: a valve; 112: a circulating line; 113: a polymerizable monomer mixture; 201: a media type dispersing machine; 202: a casing; 203: a liquid inlet; 204: a liquid outlet; 205: a holding tank; 206: a stirring motor; 207: a stirring vane; 208: a jacket; 209: a temperature controlling medium inlet; 210: a temperature controlling medium outlet; 211: a valve; 212: a line; 213: a circulating pump; 214: a line; 215: a line; 216: a mixture; 301: a media type dispersing machine; 302: a casing; 303: a liquid inlet; 304: a liquid outlet; 314: a line; 315: a line; 316: a rotor; 317: a media particle; 318: a screen for media separation; 319: a drive shaft; 320: a cooling medium inlet; 321: a cooling medium outlet; 322 a jacket; 323: a media particle discharging slit; 324: a cylindrical member; 325: a liquid discharging passage; 501: a cylindrical casing; 502: a liquid inlet; 503: a liquid outlet; 504: a cooling medium inlet; 505: a cooling medium outlet; 506: a jacket; 507: an agitator disk; 508: a media particle; 509: a media separating gap separator; 510: a drive shaft; 601: an element wire; 602: a frame; 603: an element surface; and 701: a notch.

### DETAILED DESCRIPTION OF THE INVENTION

The method of producing a polymerized toner of the present invention is a method of producing a polymerized toner comprising the steps of:

(1) preparing a polymerizable monomer composition containing a polymerizable monomer and a colorant;

(2) forming a droplet of the polymerizable monomer composition by dispersing the polymerizable monomer composition in an aqueous dispersion medium; and

(3) forming a colored resin particle by polymerizing the droplet of the polymerizable monomer composition,

wherein the step (1) includes a dispersing process in which a polymerizable monomer mixture containing the polymerizable monomer and the colorant is supplied to a media type dispersing machine equipped with a media particle and a screen for media separation and the colorant is dispersed in the polymerizable monomer mixture to obtain a polymerizable monomer dispersion, and

wherein a media diameter of the media particle and an aperture ratio of the screen for media separation satisfy the following formulas 1 and 2:

0.01 mm≦(media diameter)≦0.3 mm Formula 1:

50≦(Aperture ratio)/(Media diameter)≦260 Formula 2:

wherein, in the Formula 2, the aperture ratio is a value expressed in percentage and the media diameter is a value expressed in millimeter.

Hereinafter, a production process of the polymerized toner of the present invention will be explained in order.

In the present invention, the dispersion process in the step (2) forming a droplet may be referred to as a preliminary dispersing process 1A, if a preliminary dispersion is performed, and a dispersing process 1B, and a dispersing machine used in the preliminary dispersing process 1A may be referred to as a “preliminary dispersing machine” and a media type dispersing machine equipped with a screen for media separation used in the dispersing process 1B may be referred to as a “media type dispersing machine.” Also, a material mixture containing a polymerizable monomer and a colorant, which is not subject to dispersion treatment with the preliminary dispersing machine or the media type dispersing machine, may be referred to as a “polymerizable monomer mixture.” A mixture in which a colorant contained is finely dispersed by means of the preliminary dispersing machine may be referred to as a “preliminary dispersion polymerizable monomer mixture.” A mixture in which a colorant contained is finely dispersed with the media type dispersing machine may be referred to as a “polymerizable monomer dispersion.”

### 1. Process (1) of Preparing Polymerizable Monomer Composition

A polymerizable monomer composition contains a polymerizable monomer and a colorant, and if required, other toner components such as a colorant dispersing agent, a charge control agent, a release agent, a polymerization initiator, a molecular weight modifier or the like.

In the preparing process of the polymerizable monomer composition, after mixing a polymerizable monomer, a colorant and other components together, the mixture may be dispersed with the media type dispersing machine. In order to disperse a colorant finely and uniformly, it is preferable to prepare the polymerizable monomer composition in such a manner that a polymerizable monomer mixture obtained by mixing a polymerizable monomer, a colorant and preferably a colorant dispersing agent is subject to the preliminary dispersing process 1A, if required, and then to the dispersing process 1B by means of the media type dispersing machine followed by dispersing or dissolving other toner components in a polymerizable monomer dispersion obtained by the process 1B, if necessary.

A part of said other toner components may be added to an aqueous dispersion medium when forming a droplet of the polymerizable monomer composition in the aqueous dispersion medium so as to be contained in the droplet.

In order to suppress partial polymerization before implementing a polymerization process by rising temperature, the polymerization initiator may be preferably added, after the polymerizable monomer composition is added to the aqueous dispersion medium, to a suspension which is in a phase prior to the end of a process of forming a droplet. Or, the polymerization initiator may be preliminarily added to the polymerizable monomer composition before the polymerizable monomer composition is added to the aqueous dispersion medium.

In such a manner that the polymerizable monomer mixture, which is substantially comprised of the polymerizable monomer and the colorant, is dispersed and most of said other toner components are added after the dispersing process 1B, the colorant can be finely and uniformly dispersed in a short time with efficiency by means of a relatively compact-sized preliminary dispersing machine or holding tank, or a small media type dispersing machine.

Hereinafter, each component of the polymerizable monomer composition, the preliminary dispersing process 1A implemented according to need and the dispersing process 1B by means of the media type dispersing machine equipped with a screen for media separation will be explained in detail.

### <Component of Polymerizable Monomer Composition>

Major components of the polymerizable monomer composition will be described before explaining procedures and equipments of the dispersing process (including the preliminary dispersing process 1A and the dispersing process 1B).

### (1) Polymerizable Monomer

In the present invention, a monovinyl monomer may be used as a main component of the polymerizable monomer. As the monovinyl monomer, for example, there may be an aromatic vinyl monomer such as styrene, vinyl toluene, α-methyl styrene or the like; acrylic acid and methacrylic acid; an acrylic acid derivative such as methyl acrylate, ethyl acrylate, propyl acrylate, butyl acrylate, 2-ethylhexyl acrylate, cyclohexyl acrylate, isobornyl acrylate, dimethylaminoethyl acrylate, acrylamide or the like; a methacrylic acid derivative such as methyl methacrylate, ethyl methacrylate, propyl methacrylate, butyl methacrylate, 2-ethylhexyl methacrylate, cyclohexyl methacrylate, isobornyl methacrylate, dimethylaminoethyl methacrylate, methacrylamide or the like; a monoolefin monomer such as ethylene, propylene, butylene or the like; vinyl halide and vinylidene halide such as vinyl chloride, vinylidene chloride, vinyl fluoride or the like; vinyl ester such as vinyl acetate, vinyl propionate or the like; vinyl ether such as vinyl methyl ether, vinyl ethyl ether or the like; vinyl ketone such as vinyl methyl ketone, methyl isopropenyl ketone or the like; a nitrogen-containing vinyl compound such as 2-vinylpyridine, 4-vinylpyridine, N-vinylpyrrolidone or the like.

Hot offset may be prevented if any crosslinkable polymerizable monomer is used together with the monovinyl monomer as the polymerizable monomer. The crosslinkable polymerizable monomer means a monomer having two or more polymerizable functional groups. As the crosslinkable monomer, for example, there may be an aromatic divinyl compound such as divinyl benzene, divinyl naphthalene, a derivative thereof or the like; unsaturated carboxylic acid ester of polyalcohol such as ethylene glycol dimethacrylate, diethylene glycol dimethacrylate or the like; a divinyl compound such as N,N-divinyl aniline, divinyl ether or the like; a compound having three or more vinyl groups; or the like, which may be used alone or in combination of two or more kinds. An amount of the crosslinkable monomer is generally 10 or less parts by weight, preferably from 0.01 to 7 parts by weight, more preferably from 0.05 to 5 parts by weight, most preferably from 0.1 to 3 parts by weight, with respect to the monovinyl monomer of 100 parts by weight.

It is preferable to use a macromonomer as the polymerizable monomer together with the monovinyl monomer so that shelf stability and fixing ability at a low temperature of the toner are well-balanced. The macromonomer is a large molecule which has a polymerizable carbon-carbon unsaturated double bond at the end of a polymer chain and is an oligomer or a polymer having a number average molecular weight from 1,000 to 30,000 generally. It is preferable that the number average molecular weight is in the above range since fixing ability and shelf stability of the polymerized toner can be maintained without declining solubility of the macromonomer.

As the polymerizable carbon-carbon unsaturated double bond at the end of a polymer chain of the macromonomer, there may be an acryloyl group, a methacryloyl group or the like. From the viewpoint of capability of copolymerization, the methacryloyl group is preferable. A macromonomer which provides a polymer having higher glass transition temperature than that of a polymer obtained by polymerization of a monovinyl monomer is preferable.

As the macromonomer, for example, there may be a polymer obtained by polymerization of styrene, a styrene derivative, methacrylate ester, acrylate ester, acrylonitrile, methacrylonitrile or the like alone or in combination of two or more kinds; a macromonomer having a polysiloxane skeleton; or the like. Among them, a macromonomer having hydrophilicity is preferable. Particularly, a macromonomer comprising a polymer obtained by polymerization of methacrylate ester or acrylate ester alone or in combination is preferable.

In the case of using the macromonomer, an amount of the macromonomer is generally from 0.01 to 10 parts by weight, preferably from 0.03 to 5 parts by weight, more preferably from 0.05 to 1 part by weight, with respect to the monovinyl monomer of 100 parts by weight. It is preferable that the amount of the macromonomer is in the above range since shelf stability of the polymerized toner can be maintained and fixing ability can be improved.

### (2) Colorant

As the colorant, various kinds of pigments or dyes used for a toner such as carbon black, titanium white or the like may be used.

As a black colorant, for example, there may be carbon black or nigrosine-based pigments or dyes; magnetic particles such as cobalt, nickel, iron oxide black, manganese-ferric oxide, zinc-ferric oxide, nickel-ferric oxide or the like. In the case of using carbon black, it is preferable to use carbon black having a primary particle diameter from 20 to 40 nm since high image quality can be obtained and work environment safety during toner production is not interfered.

As a colorant for a color toner, in addition to the black colorant, a yellow colorant, a magenta colorant, a cyan colorant or the like may be used generally.

As the yellow colorant, for example, a condensed azo compound, an isoindolinone compound, an anthraquinone compound, an azo metal complex, a methine compound, an allylamide compound or the like may be used. Specifically, for example, there may be C. I. Pigment Yellow 3, 12, 13, 14, 15, 17, 62, 65, 73, 74, 83, 90, 93, 95, 96, 97, 109, 110, 111, 120, 128, 129, 138, 147, 155, 168, 180, 181, 185, 186 or 213. In addition to the above, as the yellow colorant, for example, there may be Naphthol Yellow S, Hansa yellow G or C. I. Vat Yellow.

As the magenta colorant, for example, there may be a condensed azo compound, a diketo-pyrrolo-pyrrole compound, an anthraquinone compound, a quinacridone compound, a base dye lake compound, a naphthol compound, a benzimidazolone compound, a thioindigo compound or a perylene compound. Specifically, for example, there may be C. I. Pigment Red 2, 3, 5, 6, 7, 23, 31, 48, 48:2, 48:3, 48:4, 57, 57:1, 58, 60, 63, 64, 68, 81, 81:1, 83, 87, 88, 89, 90, 112, 114, 122, 123, 144, 146, 149, 150, 163, 166, 169, 170, 177, 184, 185, 187, 202, 206, 207, 209, 220, 251 or 254. In addition to the above, as the magenta colorant, for example, there may be C. I. Pigment Violet 19.

As the cyan colorant, for example, there may be a copper phthalocyanine compound and the derivative thereof, an anthraquinone compound or a base dye lake compound. Specifically, for example, there may be C. I. Pigment Blue 1, 2, 3, 6, 7, 15, 15:1, 15:2, 15:3, 15:4, 16, 17, 60, 62 or 66. In addition to the above, as the cyan colorant, for example, there may be Phthalocyanine Blue, C. I. Vat Blue or C. I. Acid Blue.

These colorants may be used alone or in combination of two or more kinds. An amount of the colorant is generally from 0.1 to 70 parts by weight, preferably from 0.5 to 50 parts by weight, more preferably from 1 to 10 parts by weight, with respect to the monovinyl monomer of 100 parts by weight.

### (3) Colorant Dispersing Agent

In a preliminary dispersing process 1A and a dispersing process 1B with the use of a media type dispersing machine equipped with a screen for media separation, the colorant dispersing agent may be preferably used to stabilize a dispersion state of the colorant. As the colorant dispersing agent, a coupling agent such as an Al coupling agent, a silane coupling agent, a titanate coupling agent or the like is preferable. An amount of the colorant dispersing agent is generally from 0.05 to 3 parts by weight, preferably from 0.2 to 2 parts by weight, with respect to the monovinyl monomer of 100 parts by weight. In order to perform a uniform dispersion efficiently, it is preferable to add the colorant dispersing agent before the preliminary dispersing process 1A or before the dispersing process 1B with the use of a media type dispersing machine equipped with a screen for media separation. It is more preferable to add the colorant dispersing agent before the preliminary dispersing process 1A.

### (4) Charge Control Agent

In order to improve a charge property of the polymerized toner, various kinds of charge control agents having positively charging ability or negatively charging ability are preferably contained in the polymerizable monomer composition. As the charge control agent, for example, there may be a metallic complex of an organic compound having a carboxyl group or a nitrogen-containing group, a metal-containing dye, nigrosine or a charge control resin.

In the present invention, the charge control resin may be preferably used. As a charge control resin having a negatively charging ability, there may be a resin which has a substituent selected from a group consisting of i) a carboxyl group or the salt thereof, ii) a phenol group or the salt thereof, iii) a thiophenol group or the salt thereof and iv) a sulfonic acid group or the salt thereof in a polymer side chain. Also, as the charge control resin having a positively charging ability, there may be a resin which has a substituent of a quaternary ammonium group or the salt thereof in a polymer side chain.

A weight average molecular weight of the charge control resin is generally from 2,000 to 50,000, preferably from 4,000 to 40,000, more preferably from 6,000 to 30,000.

An amount of the charge control agent is generally from 0.01 to 10 parts by weight, preferably from 0.1 to 10 parts by weight, with respect to the monovinyl monomer of 100 parts by weight.

### (5) Release Agent

In order to prevent hot offset or to improve a releasing characteristic upon fixing with a heating roller, various kinds of release agents used in the technical field of toner may be contained in the polymerizable monomer composition.

As the release agent, for example, there may be a low-molecular-weight polyolefin wax such as low-molecular-weight polyethylene, low-molecular-weight polypropylene, low-molecular-weight polybutylene or the like; an end-modified polyolefin wax such as a molecular-end-oxidized low-molecular-weight polypropylene, a low-molecular-weight end-modified polypropylene having a molecular end substituted by an epoxy group, a block polymer of the polypropylene and a low-molecular-weight polyethylene, a molecular-end-oxidized low-molecular-weight polyethylene, a low-molecular-weight polyethylene having a molecular end substituted by an epoxy group, a block polymer of the polyethylene and a low-molecular-weight polypropylene or the like; a natural wax such as candelilla, a carnauba wax, a rice wax, a haze wax, jojoba or the like; a petroleum wax such as paraffin, microcrystalline, petrolactam or the like, and a modified wax thereof; a mineral wax such as montan, ceresin, ozokerite or the like; a synthesized wax such as a Fischer-Tropsch wax or the like; pentaerythritol ester such as pentaerythritol tetramyristate, pentaerythritol tetrapalmitate, pentaerythritol tetrastearate, pentaerythritol tetralaurate or the like; dipentaerythritol ester such as dipentaerythritol hexamyristate, dipentaerythritol hexapalmitate, dipentaerythritol hexalaurate or the like, which may be used alone or in combination of two or more kinds.

An amount of the release agent is generally from 0.1 to 50 parts by weight, preferably from 0.5 to 20 parts by weight, more preferably from 1 to 10 parts by weight, with respect to the monovinyl monomer of 100 parts by weight.

### (6) Polymerization Initiator

As the polymerization initiator of the polymerizable monomer, for example, there may be persulfate such as potassium persulfate, ammonium persulfate or the like; an azo compound such as 4,4′-azobis(4-cyanovaleric acid), 2,2′-azobis[2-methyl-N-(2-hydroxyethyl)propionamide], 2,2′-azobis(2-amidinopropane)dihydrochloride, 2,2′-azobis(2,4-dimethylvaleronitrile), 2,2′-azobisisobutyronitrile or the like; peroxide such as di-t-butylperoxide, dicumyl peroxide, lauroyl peroxide, benzoylperoxide, t-butylperoxy-2-ethylhexanoate, t-hexylperoxy-2-ethylhexanoate, t-butylperoxypyvalate, di-isopropylperoxydicarbonate, di-t-butylperoxyisophthalate, 1,1,3,3-tetramethylbutyl peroxy-2-ethylhexanoate, t-butylperoxyisobutyrate or the like. A redox initiator, which is a combination of the above polymerization initiator and a reducing agent, may also be used.

An amount of the polymerization initiator is generally from 0.1 to 20 parts by weight, preferably from 0.3 to 15 parts by weight, more preferably from 0.5 to 10 parts by weight, with respect to the monovinyl monomer of 100 parts by weight.

### (7) Molecular Weight Modifier

A molecular weight modifier may be preferably used upon polymerization. As the molecular weight modifier, for example, there may be mercaptans such as t-dodecyl mercaptan, n-dodecyl mercaptan, n-octyl mercaptan, 2,2,4,6,6-pentamethylheptane-4-thiol or the like; halogenated hydrocarbons such as carbon tetrachloride, carbon tetrabromide or the like. The molecular weight modifier is usually added to the polymerizable monomer composition prior to initiating polymerization or can be added during polymerization.

An amount of the molecular weight modifier may be generally from 0.01 to 10 parts by weight, preferably from 0.1 to 5 parts by weight, with respect to the polymerizable monomer of 100 parts by weight.

### <Preliminary Dispersing Process 1A>

In the process of preparing the polymerizable monomer composition, in order to prevent choking of the screen for media separation so as to perform fine dispersion treatment efficiently by means of a media type dispersing machine, firstly, a polymerizable monomer mixture containing a polymerizable monomer, a colorant and, if required, other components is subject to a preliminary dispersion treatment by a dispersion method not using a media, and then the preliminarily dispersed mixture may be subject to a dispersion treatment by means of the media type dispersing machine. By implementing the dispersing process 1B after the preliminary dispersing process 1A, extremely fine and uniform dispersion can be applied to the colorant so that efficient production of the polymerized toner is possible.

Particularly, in the case that a colorant to be used has a large particle diameter or the percentage of rough and large colorants is high, it is preferable to perform the preliminary dispersing process in order to prevent choking at the screen for media separation. For instance, in the case that the polymerizable monomer mixture contains a colorant having a volume average particle diameter of 20 μm or more and/or a colorant which has a volume percentage (D₅₁) of a particle having a particle diameter of 51 μm or more by 20% or more, it is highly effective to perform a preliminary dispersion before the dispersion treatment by means of a media type dispersing machine.

A volume average particle diameter (Dv) of the colorant, which is used as a starting material, is generally 20 μm or more, frequently from 20 to 150 μm, more frequently 30 to 100 μm. Also, a volume percentage (D₅₁) of a particle having a particle diameter of 51 μm or more of a colorant, which is used as a starting material, is generally 20% or more, frequently from 20 to 95%, more frequently from 30 to 85%.

The volume average particle diameter (Dv) of a colorant and the volume percentage (D₅₁) of a particle having a particle diameter of 51 μm or more are obtained by measuring a mixture diluted with an organic solvent by a commercially-available particle diameter distribution measuring device. From the viewpoint of reproductivity of measurement, the organic solvent may be preferably a monovinyl monomer, more preferably a monovinyl monomer wherein a compound having a polar group such as a charge control agent is dissolved.

In the preliminary dispersing process 1A, it is preferable to preliminarily disperse the colorant in the polymerizable monomer mixture to make a volume average particle diameter of the colorant be less than 20 μm and a volume percentage (D₅₁) of a particle having a particle diameter of 51 μm or more of the colorant be less than 20%. It is desirable to continue the preliminary dispersion until the volume average particle diameter (Dv) of the colorant becomes preferably 19 μm or less, more preferably 18 μm or less, most preferably 15 μm or less at the end of the preliminary dispersion treatment. The lower limit of the volume average particle diameter (Dv) of the colorant subject to the preliminary dispersion is preferably 1 μm, more preferably 3 μm, further preferably 5 μm, most preferably 7 μm.

Also, in the preliminary dispersing process 1A, it is desirable to continue the preliminary dispersion until the volume percentage (D₅₁) of a colorant particle having a particle diameter of 51 μm or more becomes preferably 19% or less, more preferably 18% or less, most preferably 15% or less. The lower limit of D₅₁ of the colorant subject to the preliminary dispersion is preferably 1%, more preferably 3%, further preferably 5%, most preferably 7%.

In the preliminary dispersing process 1A, if the preliminary dispersion is not performed until the volume average particle diameter (Dv) of the colorant or the volume percentage (D₅₁) of a particle having a particle diameter of 51 μm or more becomes small enough, in the following dispersing process 1B, choking at the screen for media separation may easily occur or dispersion efficiency by means of a media type dispersing machine tends to lower even though no choking occurs. On the other hand, in the preliminary dispersing process 1A, if dispersion is continued until Dv or D₅₁ of the colorant becomes too small, the entire dispersion treatment takes long time so that dispersion efficiency may lower.

Even if the volume average particle diameter (Dv) of the colorant subject to the preliminary dispersion is 20 μm, preferably 15 μm, and the media type dispersing machine equipped with a screen for media separation is used, it is difficult to efficiently perform fine dispersion to the colorant, D₅₁ of which is 20% or less. Hence, in the preliminary dispersing process 1A, it is particularly preferable to make both Dv and D₅₁ of the colorant small.

A method of preliminary dispersion may be selected from methods beside the method using a media type dispersing machine equipped with a screen for media separation and performed. For instance, it is preferable to use a dispersing machine capable of providing mechanical shearing stress by rotating a stirring vane and supply with a polymerizable monomer mixture so as to preliminarily disperse the colorant finely in the dispersion.

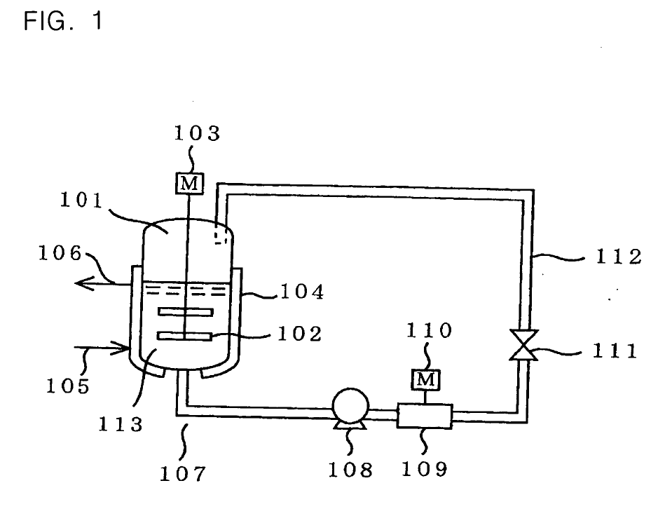

An example of a system of the preliminary dispersing process 1A is shown in FIG. 1. The preliminary dispersion system is a system comprising a holding tank 101 to supply a polymerizable monomer mixture, a dispersing machine 109 (hereinafter, it is referred to as a “preliminary dispersing machine”), a circulating line 107 to circulate the polymerizable monomer mixture between the holding tank 101 and the preliminary dispersing machine 109, and a valve 111 provided on a circulating line 112 between an outlet side of the preliminary dispersing machine 109 and the holding tank 101.

The holding tank 101 is provided with a stirring vane 102 which is activated by a stirring motor 103 to rotate. On the outer surface of the holding tank 101, a jacket 104 is disposed. A temperature controlling medium is charged into the jacket through a temperature controlling medium inlet 105 and discharged from a temperature controlling medium outlet 106 so as to control the liquid temperature in the holding tank 101.

The polymerizable monomer mixture 113 containing the polymerizable monomer and the colorant is charged into the holding tank 101. The polymerizable monomer mixture is sent to the preliminary dispersing machine 109 by a pump 108 through the circulating line 107. A stirring vane of the preliminary dispersing machine 109 is activated by a motor 110. The polymerizable monomer mixture preliminarily dispersed by the preliminary dispersing machine 109 is circulated into the original holding tank 101 through the circulating line 112 provided with the valve 111.

In the present invention, the preliminary dispersion is performed by applying mechanical shearing stress to the colorant in the polymerizable monomer mixture in the preliminary dispersing process 1A. As the preliminary dispersing machine, a stirring device with high shearing stress is preferable. Generally, there is no particular limitation to the preliminary dispersing machine as far as the preliminary dispersing machine can introduce the polymerizable monomer mixture in a treating member and disperse the mixture by rotating a stirring vane provided in the treating member at high speed. There is no particular limitation to the shape or structure of the stirring vane (rotor) as far as the stirring vane (rotor) is able to apply high shearing stress to the polymerizable monomer mixture.

As such a dispersing machine, for example, there may be:

(a) a stirring device represented by Ebara Milder (product name; manufactured by Ebara Corporation), CAVITRON (product name; manufactured by EUROTEC, Ltd.), DRS2000 (product name; manufactured by IKA Works, Inc.) or the like, that is to say, a stirring device equipped with a comb-shaped rotor and a stator both disposed on the same core, wherein the rotor rotates at high speed and a mixture is stirred and circulated from the inner side of the rotor to the outer side of the stator so that the mixture is stirred in a space between the rotor and the stator;

(b) a stirring device represented by CLEARMIX CLM-0.8S (product name; manufactured by M TECHNIQUE Co., Ltd.), that is to say, a device which performs stirring by the action of shearing stress, force of collision, pressure variation, cavitation and potential core generated at a rotor rotating at high speed and a screen surrounding the rotor;

(c) a turbine-type stirring machine represented by T. K. HOMO MIXER (product name; manufactured by PRIMIX Corporation);

(d) a stirring device represented by T. K. FILMICS (registered trademark; manufactured by PRIMIX Corporation), that is to say, a device to perform stirring in such a manner that a polymerizable monomer mixture to be treated is pressed against the sidewall of a dispersing tank by centrifugal force to form a liquid film and an edge of a high-speed rotating stirring member (rotor) contacts the liquid film; or the like.

It is preferable to perform the preliminary dispersion of the polymerizable monomer mixture containing the polymerizable monomer and the colorant in such a manner that at least two times of circulation (circulation number of at least two) is performed by a preliminary dispersing machine using, for example, the preliminary dispersing system shown in FIG. 1. The circulation number can be calculated by the following formula:

circulation number θ (times)=processing time (minutes)/time (t) required for one circulation (minutes/times).

Time (t) required for one circulation is obtained by the following formula:

t=W/V

wherein, t: time required for one circulation (minutes/times); W: amount to be charged into a holding tank (kg); and V: treated flow amount (kg/min).

The circulation number in the preliminary dispersing process 1A may be accordingly selected depending on the size of a preliminary dispersing machine to be used, the type of a colorant to be used, the amount of a polymerizable monomer mixture and so on. The circulation number is preferably about 2 to 20 times.

A peripheral speed at the edge of the stirring vane (rotor) of the preliminary dispersing machine is generally from 15 to 60 m/s, preferably from 17 to 55 m/s, more preferably from 20 to 50 m/s. If the peripheral speed exceeds the above range, cavitation may occur, shearing stress may be hardly provided on a colorant, and finally enough dispersion may not be obtained. If the peripheral speed is lower than the above range, shearing stress may not be fully obtained.

In the case of performing the preliminary dispersion by the preliminary dispersing machine, in order to prevent temperature of the polymerizable monomer mixture (liquid temperature) rising due to heat by shear, it is desirable to perform the preliminary dispersion while holding a temperature variation range of the polymerizable monomer mixture before and after the preliminary dispersion preferably at 30° C. or less, more preferably at 15° C. or less, by forced cooling. Further, in addition to the holding tank 101, the circulating lines 107 and 112 may be provided with a jacket to perform cooling.

In the present invention, when dispersing preliminarily, in order to prevent cavitation due to high-speed stirring, it is preferable to increase the inner pressure of the preliminary dispersing machine before operating. As described above, if cavitation occurs, shearing stress onto the colorant may decrease and dispersion efficiency may lower. To increase the inner pressure of the preliminary dispersing machine, for example, as the system shown in FIG. 1, the valve 111, which is provided on the circulating line 112 provided at the outlet side of the preliminary dispersing machine 109, may be adjusted so that the inner pressure of the preliminary dispersing machine 109 can be accordingly adjusted. The inner pressure (gage pressure) of the preliminary dispersing machine may be adjusted to be in the range preferably from 0.01 to 15 MPa, more preferably form 0.05 to 10 MPa, most preferably from 0.1 to 5 MPa.

### <Dispersing Process 1B>

The polymerizable monomer mixture containing the polymerizable monomer and the colorant is subject to a dispersion treatment using a media type dispersing machine equipped with a media particle and a screen for media separation, if necessary, after the preliminary dispersion treatment (to obtain a preliminarily-dispersed polymerizable monomer mixture). Hereinafter, the term “polymerizable monomer mixture” includes the preliminarily-dispersed polymerizable monomer mixture which is subject to the preliminary dispersion treatment when needed.

In the present invention, a media particle having a relatively small media diameter as well as a screen for media separation having an aperture ratio having a certain relationship with the media diameter are used for such a media type dispersing machine, thereby, choking at the screen for media separation may hardly occur in spite of using the media particle having a relatively small media diameter.

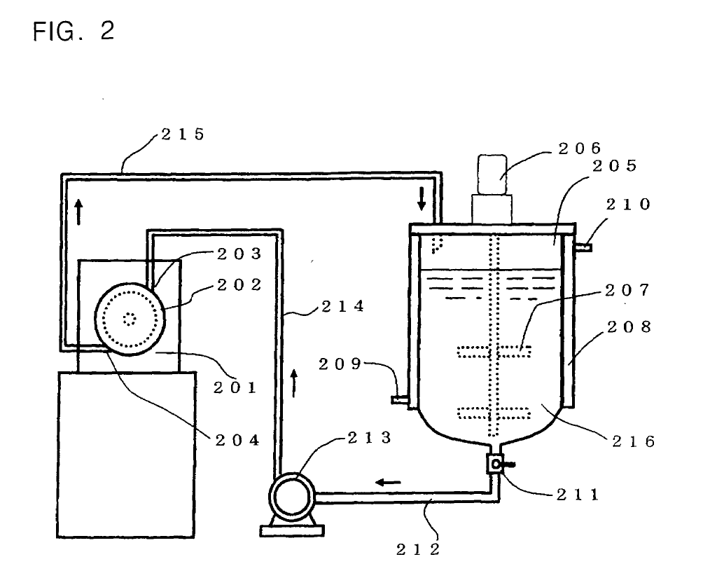

An example of a dispersion system using a media type dispersing machine equipped with a screen for media separation is shown in FIG. 2. The dispersion system of FIG. 2 has a structure that a media type dispersing machine 201 and a holding tank 205 are connected with a downward flow comprising lines 212 and 214, and an upward flow comprising a line 215. As the holding tank 205, the holding tank 101 used in the preliminary dispersing process 1A or a different holding tank may be used.

In the holding tank 205, a stirring vane 207 which is activated to rotate by a stirring motor 206 is provided. On the outer circumference of the holding tank 205, a jacket 208 is disposed. A temperature controlling medium is charged into the jacket 208 through a temperature controlling medium inlet 209 and discharged from a temperature controlling medium outlet 210 so as to control the liquid temperature in the holding tank 205 to a desired temperature.

The polymerizable monomer mixture containing the polymerizable monomer and the colorant is charged into the holding tank 205 and stirred. As the polymerizable monomer mixture, the polymerizable monomer mixture containing the colorant preliminarily dispersed in the preliminary dispersing process 1A is used. By operating a circulating pump 213, the polymerizable monomer mixture in the holding tank 205 is charged in a casing 202 (it may be referred to as a “container” or a “stator”) from a liquid inlet 203 of the media type dispersing machine 201 via a valve 211, the line 212, the circulating pump 213 and the line 214.

A strong shearing stress is applied to the polymerizable monomer mixture in the media type dispersing machine 201 and the colorant is finely pulverized and dispersed. The polymerizable monomer mixture, wherein the colorant is finely dispersed, is charged into the holding tank 205 through a liquid outlet 204 and the line 215. In order to achieve more uniform and finer dispersion of the colorant, the polymerizable monomer mixture once circulated in the media type dispersing machine may be circulated again in the same media type dispersing machine 201 at a desired circulation number.

The polymerizable monomer is likely to start partial polymerization when heated at high temperature. On the other hand, when viscosity of the polymerizable monomer mixture or the polymerizable monomer dispersion is too high, heat generated in the dispersion system increases. Hence, it is desirable to control the liquid temperature in the holding tank 205 to, for example, 30° C. or less, preferably in the range from 10 to 30° C., by supplying the jacket 208 with a temperature controlling medium such as cool or hot water etc.

Similarly, when a strong shearing stress is applied in the media type dispersing machine 201, the liquid temperature of the polymerizable monomer mixture or the polymerizable monomer dispersion may increase and partial polymerization of the polymerizable monomer may easily occur. Hence, it is desirable to control the liquid temperature to be in the range from about 10 to 30° C. by supplying a jacket of the media type dispersing machine 201 with a temperature controlling medium such as cool water or the like.

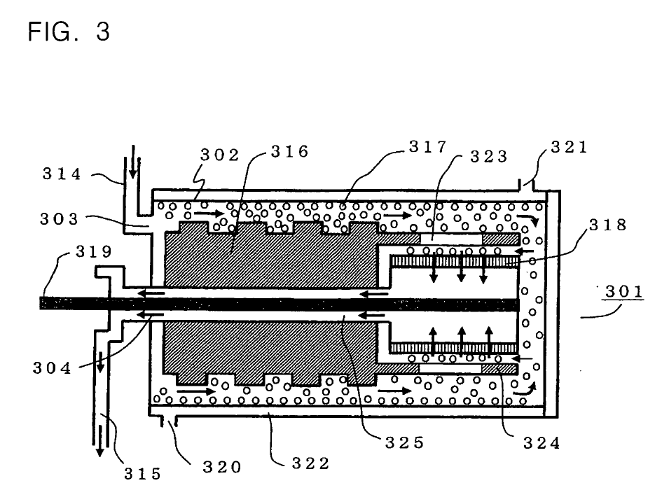

A sectional view of a constitutional example of the media type dispersing machine used in the present invention is shown in FIG. 3. The media type dispersing machine 301 has a structure that a drive shaft 319, a rotor 316 which is provided on the drive shaft 319 and can simultaneously rotate as the drive shaft 319 rotates, and a screen for media separation 318 are arranged in a casing 302 having a liquid inlet 303 and a liquid outlet 304.

An internal space formed between the inner surface of the casing 302 and the outer surface of the rotor 316 is a dispersing room to store a media particle 317. At one end of the rotor 316, a cylindrical member 324 provided with plural media particle discharging slits 323 is disposed. The screen for media separation 318 is provided inside the cylindrical member 324. It is designed that a liquid charged into the casing 302 through the liquid inlet 303 flows through the screen for media separation 318 and a liquid discharging passage 325 so as to be discharged from the liquid outlet 304. The liquid discharging passage 325 is arranged, for instance, between the drive shaft 319 and the rotor 316. The liquid discharging passage 325 may be formed in the rotor 316.

As the motor (not shown) mounted on the media type dispersing machine rotates the drive shaft 319, the rotor 316 and the screen for media separation 318 both disposed on the drive shaft 319 rotate. The polymerizable monomer mixture containing the polymerizable monomer and the colorant, which is continuously supplied into the casing 302 from a line 314 and through the liquid inlet 303, receives a lot of shearing stress due to centrifugal force generated by rotation of the rotor 316 and an action of the media particle 317. Thereby, the colorant can be finely dispersed in the polymerizable monomer mixture.

The polymerizable monomer dispersion having the finely dispersed colorants flows through the screen for media separation 318 and the liquid discharging passage 325 so as to be discharged from the liquid outlet 304. As a result of returning the polymerizable monomer dispersion to the holding tank 205 through a line 315 and circulating again in the same media type dispersing machine, a polymerizable monomer dispersion having uniformly and finely dispersed colorants can be obtained.

In the dispersion system shown in FIG. 2, the circulating pump 213 is activated to continuously supply the polymerizable monomer mixture or the polymerizable monomer dispersion into the media type dispersing machine. Hence, the polymerizable monomer dispersion having the finely dispersed colorants flows through the screen for media separation 318 and is continuously discharged to the exterior (for instance, the inside of the holding tank) from the liquid outlet 304 due to discharge pressure of the circulating pump 213. The screen for media separation 318 is provided with a latticed or net-like screen. Since the media particle 317 used is larger than a mesh or a lattice of the screen, the media particle 317 cannot pass through the screen for media separation.

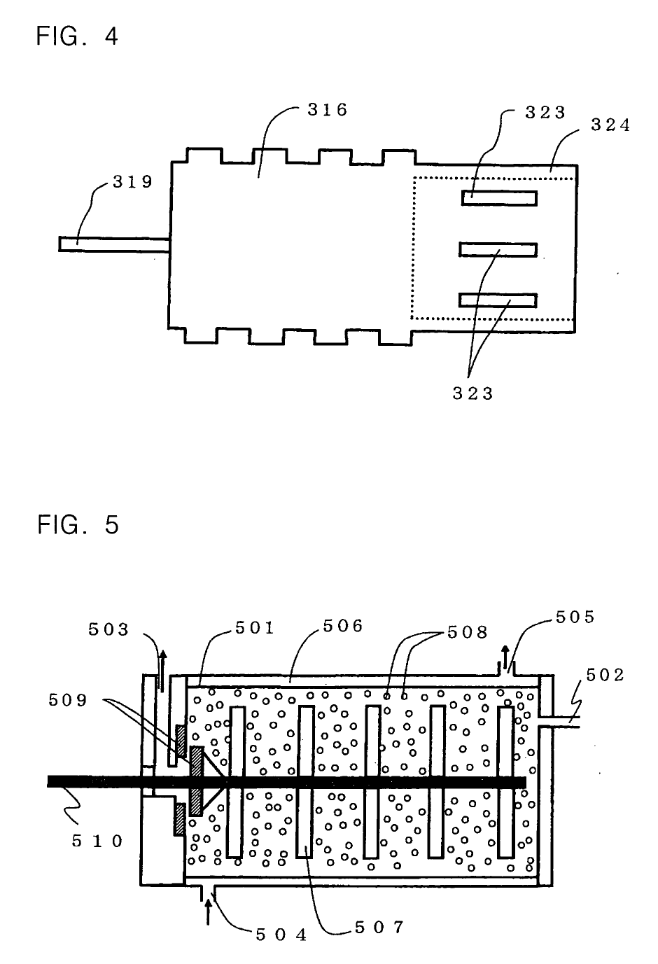

Since the screen for media separation is disposed on the drive shaft 319 and rotates as the drive shaft 319 rotates, an overall shape of the screen for media separation is generally cylindrical. Specifically, the outer circumference of the cylinder is formed of the screen. One end of the cylinder is closed and the other end is provided with an aperture connected with the liquid discharging passage 325. As shown in FIG. 3 and FIG. 4, one end of the rotor 316 is provided with the cylindrical member 324, which is provided with the several slits 323. Inside the cylindrical member, the screen for media separation 318 is disposed.

The size of the slit 323 is adjusted so that a media particle can pass through the slit. In the dispersing process, the polymerizable monomer dispersion having the finely dispersed colorants reaches the surface of the screen for media separation 318 as well as the media particle 317. Due to centrifugal force of the screen for media separation 318 under rotating, the media particle 317 passes through the slit 323, formed on the cylindrical member 324 of the rotor 316 and returns to the dispersion room so that only the polymerizable monomer dispersion is discharged to the exterior from the liquid outlet 304.

Therefore, with the media type dispersing machine, it is possible to prevent uneven distribution such as retention or the like of the media particle 317 to the surface of the screen for media separation 318. That is, the media type dispersing machine is excellent in media separation with media separating member thereof, and choking at the media separating member in the dispersion process, which may cause increase in inner pressure, can be prevented. If inner pressure of the media type dispersing machine increases in the dispersion process, it is usually required to stop operation or to mild operating conditions. However, the media type dispersing machine makes effective operation possible and does not reduce dispersion efficiency since the media type dispersing machine is excellent in media separation.

It is preferable that a part, which contacts with the polymerizable monomer mixture or the polymerizable monomer dispersion of the rotor or the casing, of the media type dispersing machine equipped with a screen for media separation used in the present invention is made of a material having Rockwell Hardness C-Scale (HRC) of 20 or more. By using the material having Rockwell Hardness C-Scale (HRC) of 20 or more, it is possible to prevent wear generated by sliding friction between the rotor or the casing and the media particle 317, which is filled in the inner space between the rotor and the casing, and thereby it is possible to prevent contamination of the polymerizable monomer dispersion due to a contaminant generated by the wear.

A peripheral speed at the edge of the rotor of the media type dispersing machine equipped with a screen for media separation is preferably 2 m/sec or more, more preferably 4 m/sec or more, most preferably 8 m/sec or more. By increasing the peripheral speed, a colorant can be efficiently dispersed in a short time.

The rotor may be made of, for example, a ceramic with high hardness such as zircon, zirconia or the like, a metal with high hardness such as steel or the like, or a polymer material such as ultrahigh molecular weight polyethylene, nylon or the like.

A media particle to be filled inside the media type dispersing machine is made of, for example, a ceramic with high hardness such as zircon, zirconia or the like, or a metal with high hardness such as steel or the like. The media particle is generally a spherical particle. The media particle may be a particle which is not in an absolute spherical shape such as an elliptic shape.

A media diameter of the media particle may be 0.01 mm or more, preferably 0.03 mm or more, more preferably 0.05 mm or more, and 0.3 mm or less, preferably 0.2 mm or less, more preferably 0.1 mm or less. In the case that the media diameter is less than the above range, the diameter of the aperture of the screen for media separation is required to be extremely small. In some cases, backbone parts of the screen such as wires and so on are densely gathered to reduce the diameter of the aperture, and an aperture ratio of the screen may be hardly raised. Hence, choking at the screen for media separation may easily occur. On the other hand, it is hard to fully disperse the colorant if the media diameter exceeds the above range.

The media particles are generally uniform in shape and size and there is almost no problem of variation in shape or size. If there is variation in shape or size of the media particles, a volume average particle diameter of the media particles is considered as the media diameter. If the value of the media diameter is in the above range, the media particles may be used in the present invention.

The media diameter is a diameter of the media particle when the media particle is absolutely spherical. In the case that the media particle is not absolutely spherical, the media diameter can be obtained using the following formula 3.

$$\begin{matrix}Formula 3 \text{:} & \\ Media diameter ( mm ) = \frac{Major axis + minor axis}{2} & \end{matrix}$$

Ratio of volume of the media particle (filling ratio) with respect to the volume of the space inside the media type dispersing machine where the media particle is present is preferably from 60 to 95 volume percent, more preferably from 70 to 90 volume percent. Herein, the space inside the media type dispersing machine where the media particle is present is all spaces where the media particle can be present in the dispersion process using the media type dispersing machine. For instance, it may be a space formed between the inner surface of the casing 302 and the outer surface of the rotor 316, a space formed between the inner surface of the cylindrical member 324 and the screen for media separation 318, or the like. The volume of such a space can be specified by, for example, a method of measuring the volume of water which is filled in and then discharged from the space, or the like.

By increasing the filling ratio of the media particle, pulverization and dispersion efficiency of the colorant becomes excellent so as to prevent a short path of the polymerizable monomer mixture or the polymerizable monomer dispersion in the dispersing room.

The screen for media separation of the media type dispersing machine is provided with a latticed or net-like screen. The screen is provided with an aperture (pore diameter) to separate a media particle by the action of the media particle from the polymerizable monomer mixture containing the polymerizable monomer having the finely dispersed colorants.

As the screen for media separation, there may be a metal mesh screen, a resin mesh screen or a punching metal screen.

Among the above, in the case of enlarging the aperture (pore diameter) of the metal mesh screen to raise dispersion efficiency of the colorant, a thin metal wire needs to be used. Consequently, strength of the metal wire weakens and the metal wire may be broken when reaching limit thereof. Hence, in order to obtain the aperture (pore diameter) with a desired size, it is important to select a metal wire with a diameter having strength not to cause breaking of the metal wire.

In the case of using the resin mesh screen, it is important to select a resin mesh screen having sufficient solvent resistance and mechanical strength.

In the case of using the punching metal screen, there is limitation in a plate thickness of a material metal plate, a punched hole size provided on the metal plate and a distance between the punched holes upon manufacturing. Hence, it is important to appropriately control the thickness of the metal plate, the size of the punched hole and the distance between the punched holes to obtain a mesh screen with high filtering ability.

As the screen for media separation, a notch wire type or a wedge wire type cylindrical screen may be preferably used.

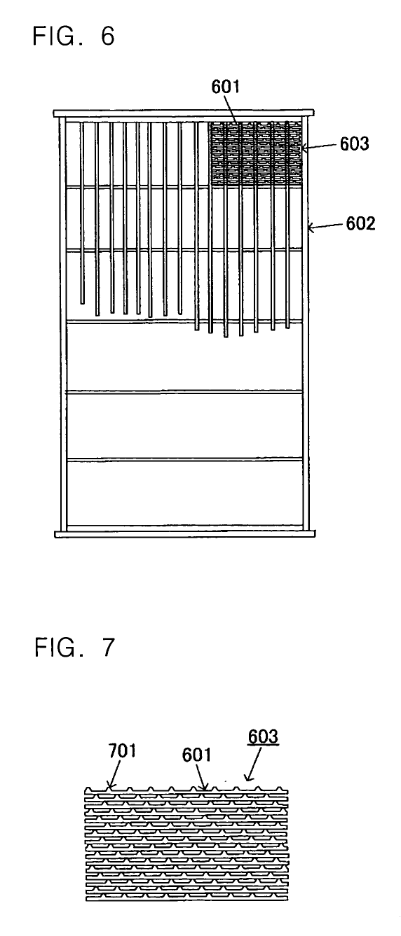

A side view (partially omitted) of a constitutional example of the notch wire type screen is shown in FIG. 6. Also, an enlarged sectional view of an element surface 603, which is an essential part of FIG. 6, is shown in FIG. 7. In FIG. 6 and FIG. 7, a single continuing element wire 601, which is provided in an extended manner in a longitudinal direction of the single continuing element wire 601 keeping an even pitch interval and is provided with notches 701 which project from the element wire 601 in the same direction at even height and are molded integrally, is wound evenly in a coil-forming manner around a cylindrical structured frame 602, and the adjacent element wires 601 closely contact with each other via the notches 701 in the axial direction of the frame 602 so as to form many apertures. Also, the tubular element surface 603 is formed on the outer circumference surface of the frame 602. As the element material, stainless-steel material such as SUS304, SUS316 or the like is preferable.

A diameter of the aperture of such a notch wire type or a wedge wire type cylindrical screen can be controlled freely by the pitch interval and the height of the projection of the notch or the wedge. In addition, strength of the mesh screen can be controlled freely by changing the cross-sectional area of the element wire.

The diameter of the aperture (the width of the pore diameter) is required to be controlled depending on the media diameter so as to maximize the filtering ability of the screen. Herein, the diameter of the aperture is a size of the aperture, which is defined as the maximum diameter of an absolute sphere which can pass through the aperture. Specifically, it is a diameter in the case that the aperture is circular. It is a minor axis in the case of an oval aperture, and it is a shorter axial length in the case of a rectangular aperture.

In the present invention, by using a media particle having a media diameter which is in the range obtained by the Formula 1 together with a screen for media separation having an aperture ratio which satisfies the following relational expression (Formula 2) with the media diameter of the media particle, it is able to perform continuous dispersion treatment for a long time without choking of the screen for media separation and damage to the screen in spite of using a media particle which is relatively small in diameter. Hence, the colorant can be dispersed finely and evenly in the polymerizable monomer in an efficient manner.

If a value calculated by the Formula 2 is less than the above range, choking at the screen may easily occur. On the other hand, in the case that value calculated by the Formula 2 is larger than the above range, a thin wire is used to increase the aperture ratio and a proportion of the area of the mesh frame with respect to the whole area of the screen decreases so that the screen may easily break.

$$\begin{matrix}Formula 2 : \\ 50 \leq \frac{( Aperture ratio )}{( Media diameter )} \leq 260\end{matrix}$$

wherein, the aperture ratio is a value expressed in percentage and the media diameter is a value expressed in millimeter.

The aperture ratio (%) is obtained by the following Formula 4.

$$\begin{matrix}Formula 4 \text{:} & \\ Aperture ratio ( \% ) = \frac{Total area of aperture ( {cm}^{2} )}{Total area of screen ( {cm}^{2} )} \times 100 & \end{matrix}$$

In the case of performing dispersion treatment using the media type dispersing machine, generally, the polymerizable monomer mixture in the holding tank 205 is supplied to the media type dispersing machine 201 so as to start dispersion treatment. To attain a sufficient degree of dispersion of the colorant, the polymerizable monomer dispersion which is subject to dispersion treatment and dispersed is preferably supplied to the media type dispersing machine again and subject to the dispersion treatment by circulating at a circulation number of two or more. The circulation number (θ) can be calculated by the following formula:

circulation number θ (times)=processing time (minutes)/time (t) required for one circulation (minutes/times).

Time (t) required for one circulation is obtained by the following formula:

t=W/V

wherein, “t (minutes/times)” is time required for one circulation; “W (kg)” is an amount to be charged into holding tank; “V (kg/min)” is an amount of liquid supplied to circulating pump.

The circulation number in the dispersion process 1B may be adequately selected based on the size of the media type dispersing machine to be used, the type of a colorant, an amount of the liquid to be dispersed and so on. The circulation number is preferably from about 2 to 30 times, more preferably from about 3 to 20 times, most preferably from about 4 to 15 times.

An amount of the liquid supplied to the circulating pump (kg/min) is, specifically, a supply rate of the polymerizable monomer mixture from the holding tank 205 to the media type dispersing machine 201.

The polymerizable monomer dispersion obtained after the above process exhibits high viscosity when the colorant is finely dispersed in the dispersion. In the present invention, it is preferable that the polymerizable monomer dispersion obtained by the dispersing process has kinematic viscosity from 300 to 2,500 cP (from 300 to 2,500 mPa·s), which is measured with a B-type viscometer at 25° C.

In the polymerizable monomer dispersion, an additive component such as a charge control agent, a release agent or the like beside the colorant may be added, if required, and may be mixed with the use of a dispersing machine or an agitator when necessary. Thereby, a polymerizable monomer composition can be obtained.

The obtained polymerizable monomer composition is dispersed in an aqueous dispersion medium by an emulsifying method or a suspension method so as to obtain a droplet of the polymerizable monomer composition. The obtained droplet is polymerized in the aqueous dispersion medium in the presence of a polymerization initiator so as to obtain a colored resin particle.

In the process of producing the colored resin particle, a polymerization method such as a suspension polymerization method, a dispersion polymerization method, an emulsion polymerization method or the like may be employed.

The suspension polymerization method comprises a process of polymerizing a polymerizable monomer composition containing at least a colorant and a polymerizable monomer in an aqueous dispersion medium. As the aqueous dispersion medium, an aqueous dispersion medium containing a dispersion stabilizer is generally used. In the suspension polymerization method, firstly, a polymerizable monomer composition is suspended in an aqueous dispersion medium containing a dispersion stabilizer to form a fine droplet. Then, the obtained fine droplet is subject to suspension polymerization so as to form a colored resin particle. If required, in the presence of the colored resin particle, a process of further polymerizing a polymerizable monomer for shell may be added to form a colored resin particle having a core-shell structure.

As the emulsion polymerization method, the following method may be employed: firstly, a polymerizable monomer composition containing a polymerizable monomer and a colorant is subject to emulsion polymerization in an aqueous dispersion medium containing an emulsifier, and thus obtained colored resin fine particle is aggregated and enlarged until the colored resin fine particle has a diameter of a toner.

Among the polymerization methods, the suspension polymerization method and the emulsion polymerization method are preferable. The suspension polymerization method is particularly preferable in terms that a spherical colored resin particle having a desired particle diameter can be easily obtained and a colored resin particle having the core-shell structure can be easily produced. Accordingly, focusing on the suspension polymerization method, “2. Process (2) of forming droplet of polymerizable monomer composition” and “3. Process (3) of forming a colored resin particle” will be hereinafter explained.

### 2. Process (2) of Forming Droplet of Polymerizable Monomer Composition

The aqueous dispersion medium used to form a droplet may be solely water, but may be water with a water-soluble solvent. As the water-soluble solvent, for example, there may be lower alcohol such as methanol, ethanol, isopropanol or the like; low-molecular ketones such as dimethylformamide; tetrahydrofuran, acetone, methyl ethyl ketone or the like.

As the dispersion stabilizer, there may be an acid or alkali-soluble inorganic compound such as a metal compound or the like such as sulfate including barium sulfate, calcium sulfate or the like; carbonate including barium carbonate, calcium carbonate, magnesium carbonate or the like; phosphate including calcium phosphate or the like; metal oxide including aluminum oxide, titanium oxide or the like; metal hydroxide including aluminum hydroxide, magnesium hydroxide, ferric hydroxide or the like. Also, an organic compound such as a water-soluble polymer including polyvinyl alcohol, methyl cellulose, gelatin or the like; an anionic surfactant; a nonionic surfactant; an ampholytic surfactant or the like; may be used together. The dispersion stabilizer may be used alone or in combination of two or more kinds.

Among the above dispersion stabilizers, a dispersion stabilizer containing a colloid of the metal compound, particularly a hardly water-soluble metal hydroxide, is preferable since a particle size distribution of the colored resin particle can be narrowed, and a residual amount of the dispersion stabilizer after washing is small so that a polymerized toner to be obtained can sharply reproduce an image and environmental stability of the toner may not be decreased.

As the hardly water-soluble metal compound, there may be sulfate including barium sulfate, calcium sulfate or the like; carbonate including barium carbonate, calcium carbonate, magnesium carbonate or the like; phosphate including calcium phosphate or the like; metal oxide including aluminum oxide, titanium oxide or the like; metal hydroxide including aluminum hydroxide, magnesium hydroxide, ferric hydroxide or the like.

There is no limitation due to the method of production to the colloid of the hardly water-soluble metal compound. For example, colloid obtained by controlling pH of an aqueous solution of a water-soluble polyvalent metal compound to 7 or more is preferable. Particularly, colloid produced by a reaction of a water-soluble polyvalent metal compound with a hydrated alkali metal salt in an aqueous phase is preferable.

A device to form a droplet by dispersing the polymerizable monomer composition in the aqueous dispersion medium may not be particularly limited. For example, a device capable of high dispersion such as an in-line type emulsifying and dispersing machine (product name: Ebara Milder; manufactured by Ebara Corporation), a high-speed emulsifying and dispersing machine (product name: T. K. Homomixer MARK II; manufactured by PRIMIX Corporation) or the like may be used.

By using such a dispersing machine, the polymerizable monomer composition is dispersed in the aqueous dispersion medium containing the dispersion stabilizer and stirred so as to form a uniform droplet of the polymerizable monomer composition, which is generally a primary droplet having a volume average particle diameter from about 50 to 1,000 μm.

A polymerization initiator is added to a suspension having the dispersed primary droplets and mixed. Next, the suspension is stirred with a high-speed rotating and shearing type dispersing machine so as to prepare a suspension containing a secondary droplet, a particle diameter of which is similarly small to that of the target colored resin particle, generally a volume average particle diameter from about 1 to 12 μm.

### 3. Process (3) of Forming Colored Resin Particle

The aqueous suspension obtained by the above-mentioned process (2) of forming a droplet is charged into a polymerization reactor and heated to start polymerization so as to form a colored resin particle. A polymerization temperature of the polymerizable monomer composition may be preferably 50° C. or more, more preferably 60 to 95° C. Also, a polymerization reaction time may be preferably from 1 to 20 hours, more preferably from 2 to 15 hours.

In order to polymerize the droplet in a stably dispersed state, the polymerization reaction may proceed while continuing dispersion treatment to form or stabilize a droplet in the polymerization process.

The colored resin particle may be used as it is as a polymerized toner or as a polymerized toner by adding an external additive. Also, it is preferable to form a so-called core-shell type (or “capsule type”) colored resin particle, which can be obtained by using the colored resin particle as a core layer and forming a shell layer, a material of which is different from that of the core layer, around the core layer. The core-shell type colored resin particle can take a balance of lowering of fixing temperature and prevention of blocking at storage of a polymerized toner by covering the core layer comprising a substance having a low-softening point with a substance having a higher softening point.

A method for producing the core-shell type colored resin particle mentioned above may not be particularly limited, and may be produced by a conventional method. For instance, a core layer, which is a colored resin particle obtained by a suspension polymerization method or one of other wet methods, is covered with a shell layer by a conventionally known method such as an in situ polymerization method, a phase separation method, a spray dry method, an interface reaction method or the like. It is preferable that a colored resin particle produced by the polymerization method is covered with a shell layer by the in situ polymerization method or the phase separation method from the viewpoint of production efficiency.

The method of producing the core-shell type colored resin particle according to the in situ polymerization method will be hereinafter described.

A polymerizable monomer (a polymerizable monomer for shell) for forming a shell layer and a polymerization initiator are added to an aqueous medium to which a colored resin particle is dispersed followed by polymerization, thus the core-shell type colored resin particle can be obtained.

As the polymerizable monomer for shell, the above-mentioned polymerizable monomer or the like can be similarly used. Among them, a monomer which provides a polymer having Tg of more than 80° C. such as styrene, acrylonitrile, methyl methacrylate or the like may be preferably used alone or in combination with two or more kinds.

As the polymerization initiator used for polymerization of the polymerizable monomer for shell, there may be water-soluble polymerization initiators such as a metal persulfate including potassium persulfate, ammonium persulfate or the like; an azo initiator such as 2,2′-azobis[2-methyl-N-(2-hydroxyethyl)propionamide], 2,2′-azobis-[2-methyl-N-(1,1-bis(hydroxymethyl)₂-hydroxyethyl)propionamide] or the like, and so on. An amount of the polymerization initiator, with respect to the polymerizable monomer for shell of 100 parts by weight, is preferably from 0.1 to 30 parts by weight, more preferably from 1 to 20 parts by weight.

A polymerization temperature of the shell layer may be preferably 50° C. or more, more preferably from 60 to 95° C. Also, a reaction time of polymerization may be preferably for 1 to 20 hours, more preferably for 2 to 15 hours.

### 4. Colored Resin Particle

After the above-mentioned polymerization process, the following processes may be implemented in series, if required: a process of removing a volatile organic compound such as a non-reacted polymerizable monomer or the like from the aqueous dispersion medium, a process of acid or alkali washing, a process of water washing, a process of dehydration, a drying process, a process of classification, and so on. Thus, a colored resin particle (hereinafter, the colored resin particle includes both core-shell type colored resin particle and colored resin particle which is not a core-shell type) can be obtained.

A volume average particle diameter (Dv) of the colored resin particle comprising the polymerized toner of the present invention may be preferably from 5 to 10 μm, more preferably from 6 to 8 μm. If Dv is less than the above range, a flowability of the polymerized toner lowers, transferability may deteriorate, blur may generate, or printing density may lower. If Dv exceeds the above range, resolution of an image may decline.

A ratio Dv/Dp of a volume average particle diameter (Dv) and a number average particle size (Dp) may be preferably from 1.0 to 1.3, more preferably from 1.0 to 1.2. If the ratio Dv/Dp exceeds the above range, blur may generate when printing an image with the polymerized toner to be obtained, or transferability, printing density or resolution may decrease. Dv and Dp of the colored resin particle may be measured, for example, by means of Multicizer (product name; manufactured by Beckman Coulter, Inc.) or the like.

A sphericity Sc/Sr of the colored resin particle comprising the polymerized toner of the present invention is preferably from 1.0 to 1.3, more preferably from 1.0 to 1.2. If the sphericity Sc/Sr is over the above range, transferability may decline or flowability may lower so that blur may easily generate when printing an image with the polymerized toner to be obtained.

The sphericity Sc/Sr of the colored resin particle can be obtained as follows. The colored resin particle is photographed by means of an electron microscope, and thus obtained micrograph is measured by means of an image analyzer (product name: LUZEX IID; manufactured by Nireco Corporation) under the condition that the maximum area ratio of particle with respect to frame area is 2% and a total process number of particle is 100. The sphericity of the colored resin particle can be obtained by averaging the sphericity Sc/Sr of the obtained 100 colored resin particles.

Sphericity=Sc/Sr

wherein, “Sc” is an area of a circle supposing that the absolute maximum length of colored resin particles is a diameter; and “Sr” is a substantial projected area of the colored resin particle.

### 5. Polymerized Toner

In the present invention, the colored resin particle may be used as it is for developing electrophotography as a polymerized toner. Also, the colored resin particle, an external additive and, if necessary, other particles may be mixed by means of a high-speed agitator such as a Henshcel mixer or the like to form a one-component polymerized toner in order to control charge property, flowability, shelf stability or the like of a polymerized toner. Further, in addition to the colored resin particle, the external additive and other particles, if required, a carrier particle such as ferrite, iron powder or the like may be mixed by various known methods to form a two-component polymerized toner.

As the external additive, generally, there may be an inorganic particle and an organic resin particle used for the purpose of improving fluidity and charge property of the toner. For example, as the inorganic particle, there may be a particle of silica, aluminum oxide, titanium oxide, zinc oxide, tin oxide, calcium carbonate, calcium phosphate, cerium oxide or the like. As the organic resin particle, there may be a methacrylate polymer, an acrylate polymer, a styrene-methacrylate copolymer, a styrene-acrylate copolymer, a melamine resin, a core-shell type particle, the core of which is a styrene polymer and the shell of which is a methacrylate polymer, or the like. Among the above, the particle of silica and the particle of titanium oxide may be suitable, a particle of silica or titanium oxide, the surface of which is subjected to a hydrophobicity-imparting treatment, may be more preferable, the particle of silica which is subjected to a hydrophobicity-imparting treatment is most preferable. It is particularly preferable to use two or more kinds of silica which are subjected to the hydrophobicity-imparting treatment together.

An added amount of the external additive may not be particularly limited, but may be generally from 0.1 to 6 parts by weight with respect to 100 parts by weight of the colored resin particle.

### EXAMPLES

### 1. Method of Producing Polymerized Toner

The production method of the present invention will be explained further in detail with reference to examples. However, the scope of the present invention may not be limited to the following examples. Herein, “part(s)” and “%” are based on weight if not particularly mentioned.

### Example 1

In the holding tank 101 shown in FIG. 1, as a monovinyl monomer, 70 parts of styrene and 20 parts of butyl acrylate, 5.5 parts of a magenta colorant (product name: Fuji Fast Carmin 528-1; manufactured by Fuji Pigment Co., Ltd.), which is a mixture of PR31 and PR150, and 0.3 part of an aluminum based coupling agent (alkyl acetoacetate aluminum diisopropylate; product name: AL-M; manufactured by Ajinomoto Fine-Techno. Co., Inc.) were charged, and thus prepared a polymerizable monomer mixture.

As a result of measuring Dv and D₅₁ of the colorant in the polymerizable monomer mixture, Dv was 70.7 μm and D₅₁ was 68.4%.

The above polymerizable monomer mixture was subject to preliminary dispersion with the use of an in-line type emulsifying and dispersing machine (product name: Ebara Milder; manufactured by Ebara Corporation) as a preliminary dispersing machine under the condition of a peripheral speed of 23 m/s and a circulation number 0 of 26 times, thus obtained a preliminarily-dispersed polymerizable monomer mixture.

As a result of measuring Dv and D₅₁ of the colorant in the preliminarily-dispersed polymerizable monomer mixture, DV was 4.8 μm and D₅₁ was 0%. The measured viscosity was 456 cP.

The preliminarily-dispersed polymerizable monomer mixture obtained by the above-mentioned preliminary dispersing process was subject to a dispersion process by means of the dispersion system shown in FIG. 2 and the media type dispersing machine equipped with a screen for media separation shown in FIG. 3 under the following conditions:
Media particle: a zirconia bead having a particle diameter of 0.1 mm
Media filling rate: 85 volume percent
Type of screen for media separation: a notch type
Pore diameter of screen for media separation: 53 μm
Aperture ratio of screen for media separation: 21.0%
Peripheral m speed of drive shaft: 10 m/s (at the edge of the rotor).

The preliminarily-dispersed polymerizable monomer mixture obtained by the above-mentioned preliminary dispersing process was charged into the holding tank 205. At this time, a temperature controlling medium (hot or cool water) was charged from the temperature controlling medium inlet 209 of the jacket 208 and discharged from the temperature controlling medium outlet 210 so as to control the liquid temperature in the holding tank 205 to 25° C.

The preliminarily-dispersed polymerizable monomer mixture was continuously supplied from the holding tank 205 to the media type dispersing machine 201 using the circulating pump 213 and circulated. The preliminarily-dispersed polymerizable monomer mixture was subject to a dispersion process while circulating so as to obtain a polymerizable monomer dispersion having the finely dispersed magenta colorants.

In the dispersion process, a pressure (gage pressure) in the casing 302 was stably 0.04 MPa. During operation, cool water was supplied to a jacket 322 from a cooling medium inlet 320 and discharged from a cooling medium outlet 321 so that the temperature of the polymerizable monomer dispersion discharged from the liquid outlet 304 having the finely dispersed magenta colorants was controlled to 25° C.

One batch operation was completed after the dispersion process with a circulation number θ of 4 was implemented.

The above polymerizable monomer dispersion was removed from the media type dispersing machine and was subject to measurement of viscosity. Viscosity of the polymerizable monomer was 948 cP.

The above operation was continuously performed without cleaning the media type dispersing machine. The dispersion treatment of the 17th batch cycle was stopped since the pressure of the dispersion in the casing of the media type dispersing machine increased and a flow amount decreased.

Next, in 90.3 parts of polymerizable monomer dispersion having the finely dispersed magenta colorants, 10 parts of styrene as a monovinyl monomer, 5 parts of a charge control agent (styrene/acrylic resin, product name: FCA-207P; manufactured by Fujikurakasei Co., Ltd.), 0.5 part of a polymethacrylic acid ester macromonomer (product name: AA6; manufactured by Toagosei Co., Ltd.) as a macromonomer, 8 parts of dipentaerythritol hexamyristate as a release agent, 1.2 parts of t-dodecyl mercaptan as a molecular weight modifier, and 0.3 part of divinyl benzene as a crosslinkable monomer were added, stirred and dissolved, thus prepared a polymerizable monomer composition.

On the other hand, an aqueous solution of 6.5 parts magnesium chloride (a water-soluble polyvalent metal salt) dissolved in 250 parts of ion-exchanged water was gradually added into an aqueous solution of 5 parts sodium hydroxide (an alkali metal hydroxide) dissolved in 50 parts of ion-exchanged water while agitated. Thereby, an aqueous dispersion medium liquid of magnesium hydroxide colloid (hardly water-soluble metal hydroxide colloid) was prepared.

The polymerizable monomer composition was charged into thus obtained aqueous dispersion medium liquid of magnesium hydroxide colloid and agitated. Thereto, as a polymerization initiator, 5 parts of t-butylperoxy-2-ethylhexanoate (product name: PERBUTYL O; manufactured by NOF Corporation) was added. Thereafter, a high shear stirring was performed at a peripheral speed of 40 m/s and a circulation number θ of 10 by means of an in-line type emulsifying and dispersing machine (product name: CAVITRON; manufactured by: Pacific Machinery & Engineering Co., Ltd) to form droplets of the polymerizable monomer composition.

The aqueous dispersion medium liquid having the dispersed droplets of the polymerizable monomer composition was charged into the reactor furnished with a stirring vane and start polymerization in the reactor set to 90° C. When a polymerization conversion rate reached almost 100%, at the same polymerization temperature, 1 part of methyl methacrylate as a polymerizable monomer for shell and 0.1 part of 2,2′-azobis[2-methyl-N-(2-hydroxyethyl)propionamide] (product name: VA086; manufactured by Wako Pure Chemical Industries, Ltd.) dissolved in 10 parts of ion-exchanged water were added. Polymerization was further continued for 3 hours at 90° C. and stopped. Thus, an aqueous dispersion of a colored resin particle having a core-shell structure was obtained. The aqueous dispersion pH was 9.5.

The aqueous dispersion of a colored resin particle was subject to acid washing in which sulfuric acid was added to be pH at 6 or less and stirred for 10 minutes at 25° C. After dewatering by filtering, the aqueous dispersion of a colored resin particle was subject to water washing in which another 500 parts of ion-exchanged water was added to make a slurry and stirred for 10 minutes. After repeating a series of filtering, dewatering and water washing several times, the colored resin particle was filtered and separated so as to obtain a wet colored resin particle. The wet colored resin particle was charged in a vacuum dryer and subject to vacuum drying at a pressure of 30 torr and a temperature of 50° C.

The volume average particle diameter (Dv) of the dried colored resin particle was 6.38 μm and the number average particle diameter (Dp) was 5.69 μm. The volume percentage of the dried colored resin particle having a particle diameter of 16 μm or more was 0.51%, and the volume percentage of the dried colored resin particle having a particle diameter of 20 μm or more was 0.89%.

0.8 part of a silica particle (product name: TG820F; manufactured by: Cabot Corporation) which was subject to a hydrophobicity-imparting treatment and 1 part of a silica particle (product name: NEA50; manufactured by: Nippon Aerosil Co., Ltd.) which was subject to a hydrophobicity-imparting treatment were added to 100 parts of thus obtained colored resin particle, and mixed by means of a Henschel mixer so as to prepare a non-magnetic one-component polymerized toner.

### Example 2

In the same manner as Example 1 except that the aperture ratio was changed from 21.0% to 9.6% and the wire diameter was changed from 0.2 mm to 0.5 mm, a polymerized toner of Example 2 was obtained.

### Example 3

In the same manner as Example 1 except that the media diameter was changed from 0.1 mm to 0.3 mm and the aperture ratio was changed from 21.0% to 36.0%, a polymerized toner of Example 3 was obtained.

### Example 4

In the same manner as Example 1 except that the media diameter was changed from 0.1 mm to 0.3 mm, a polymerized toner of Example 4 was obtained.

### Comparative Example 1

In the same manner as Example 1 except that the aperture ratio was changed from 21.0% to 42.9% and the wire diameter was changed from 0.2 mm to 0.1 mm, a polymerized toner of Comparative example 1 was obtained.

### Comparative Example 2

In the same manner as Example 1 except that the aperture ratio was changed from 21.0% to 4.7% and the wire diameter was changed from 0.2 mm to 1 mm, a polymerized toner of Comparative example 2 was obtained.

### Comparative Example 3

In the same manner as Example 1 except that the media diameter was changed from 0.1 mm to 0.3 mm, the aperture ratio was changed from 21.0% to 80.0% and the wire diameter was changed from 0.2 mm to 0.045 mm, a polymerized toner of Comparative example 3 was obtained.

### Comparative Example 4

In the same manner as Example 1 except that the media diameter is changed from 0.1 mm to 0.3 mm, the aperture ratio was changed from 21.0% to 13.0% and the wire diameter was changed from 0.2 mm to 1 mm, a polymerized toner of Comparative example 4 was obtained.

### Comparative Example 5

In the same manner as Example 1 except that the media diameter was changed from 0.1 mm to 0.5 mm, the aperture ratio was changed from 21.0% to 37.5% and the wire diameter is changed from 0.2 mm to 0.5 mm, a polymerized toner of Comparative example 5 was obtained.

### 2. Testing Method

### (1) Measurement of Particle Diameter of Colorant

A polymerizable monomer mixture containing a polymerizable monomer and a colorant, and a preliminarily-dispersed polymerizable monomer mixture were respectively diluted 20 times with styrene solution of a charge control agent (styrene/acrylic resin, product name: FCA-207P; manufactured by Fujikurakasei Co., Ltd.) so as to obtain testing samples for measuring particle diameter. Herein, the concentration of the charge control agent in the styrene solution was 1%. Thus obtained samples were measured for a volume average particle diameter (Dv) of the colorant and a volume percentage (D₅₁) of the particle having a particle diameter of 51 μm or more by means of a particle diameter distribution measuring device (product name: SALD; manufactured by Shimadzu Corporation).

### (2) Printing Density

Plain pattern printing was performed in accordance with the following steps to evaluate printing density of each polymerized toner while a developing amount M/A (mg/cm²), which is an amount of the polymerized toner on a printing paper, was kept constant.

A commercially available printer of a non-magnetic one-component developing method, which was charged with the polymerized toner, was used to print a 50 mm×50 mm square plain pattern on a printing paper at 23° C. in humidity of 50%. At the same time, the developing amount M/A was changed by changing a development bias voltage. The developing amount M/A was calculated by the following formula after removing a printing paper with an unfixed image from the printer and blowing off the polymerized toner developed on the printing paper with the use of air.

M/A(mg/cm²)=(W1−W2)/25 cm²

wherein, W1 (mg) is weight of printing paper before blowing off the toner; and W2 (mg) is weight of printing paper after blowing off the toner.

According to the above-mentioned steps, printing conditions in which M/A of each polymerized toner was 0.5 mg/cm² were specified. Next, using each polymerized toner, plain pattern printing of a 50 mm×50 mm square having M/A of 0.5 mg/cm² was performed and printing density of thus obtained fixed image was measured by means of a reflection densitometer (product name: RD918; manufactured by Macbeth Co.).

### (3) Viscosity Measurement

Viscosity of the preliminarily-dispersed polymerizable monomer mixture after the preliminarily dispersing process and viscosity of the polymerizable monomer dispersion after the first batch dispersion process were respectively measured.

Viscosities of testing samples, which were controlled to 25° C. by means of a constant temperature water bath, were measured with the use of a B-type viscometer (product name: DV-I+ Digital Viscometer; manufactured by: Brookfield Engineering Laboratories, Inc.) as a viscosity measuring device and the following spindles by rotating a rotor at 60 rpm for one minute.
For measuring viscosity of less than 100 cP: spindle No. 1.
For measuring viscosity of 100 cP or more and less than 200 cP: spindle No. 2
For measuring viscosity of 200 cP or more: spindle No. 3

### 3. Results

Test results and major manufacturing conditions will be shown in Table 1.

TABLE 1

| | | | | | Comp. | Comp. | Comp. | Comp. | Comp. |
|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 |
| Media diameter (mm) | 0.1 | 0.1 | 0.3 | 0.3 | 0.1 | 0.1 | 0.3 | 0.3 | 0.5 |
| Wire diameter (mm) | 0.2 | 0.5 | 0.2 | 0.2 | 0.1 | 1 | 0.045 | 1 | 0.5 |
| Pore diameter (μm) | 53 | 53 | 112.5 | 53 | 80 | 53 | 180 | 150 | 300 |
| Aperture ratio (%) | 21.0 | 9.6 | 36.0 | 21.0 | 42.9 | 4.7 | 80.0 | 13.0 | 37.5 |
| Aperture ratio | 210 | 96 | 120 | 70 | 429 | 47 | 267 | 43 | 75 |
| Media diameter | | | | | | | | | |
| Viscosity of polymerizable | 948 | 912 | 344 | 368 | 899 | 1,059 | — | 423 | 320 |
| monomer dispersion after | | | | | | | | | |
| first batch dispersion | | | | | | | | | |
| process (cP) | | | | | | | | | |
| Number of times of | 16 | 10 | 20 or | 12 | 1 | 3 | 0 | 6 | 20 or |
| continuously processed | | | more | | (Screen | | (Screen | | more |
| batch | | | | | was | | was | | |
| | | | | | broken) | | broken) | | |
| Printing density | 1.45 | 1.43 | 1.38 | 1.37 | 1.41 | 1.42 | — | 1.37 | 1.20 |

### [Summary of Results]

In Examples 1 to 4 and Comparative examples 1 to 4, media particles of the present invention within the suitable range of particle media diameters (0.1 and 0.3 mm) were used.

On the other hand, in Comparative example 5, a media particle having an excessively large particle diameter (0.5 mm) was used.

The higher measured value of viscosity of the polymerizable monomer dispersion after the first batch dispersion process can be evaluated as good dispersion of a colorant in a polymerizable monomer.

The higher number of batch cycles (number of continuously processed batches) to repeat the dispersion process of the polymerizable monomer dispersion in the media type dispersing machine without cleaning the machine during operation can be evaluated as such that choking at the screen for media separation is less likely to occur.

The higher measured value of printing density of the polymerized toner can be evaluated as such that a colorant is dispersed in the polymerizable monomer more finely and uniformly and a polymerized toner with more excellent fineness is obtained.

In Example 1, the media particle having a media diameter of 0.1 mm and the screen for media separation having a value of “aperture ratio/media diameter” of 210 were used. The measured viscosity of the polymerizable monomer dispersion after the first batch dispersion process was high as 948 cP. The number of continuously processed batches was large as 16, that is, it was possible to conduct a large number of batches. Further, printing density of the polymerized toner was 1.45 mg/cm² so that it was resulted in high printing density. Hence, in Example 1, it can be considered that good dispersion of the colorant in the polymerizable monomer was performed and continuous circulation of 10 times or more without choking was possible so that a screen for media separation having the suitable aperture ratio corresponding to the used media particle was able to be chosen. Also, it was found that the polymerized toner obtained in Example 1 was a polymerized toner in which the colorant was finely and uniformly dispersed in the polymerizable monomer and also a polymerized toner with excellent fineness.

In Example 2, the media particle having a media diameter of 0.1 mm and the screen for media separation having a value of “aperture ratio/media diameter” of 96 were used. The measured viscosity of the polymerizable monomer dispersion after the first batch dispersion process resulted in 912 cP, which was comparably high as that of Example 1. On the other hand, the number of continuously processed batches was 10 and it was less than Example 1. Printing density of the polymerized toner was 1.43 mg/cm² and it was slightly lower than that of Example 1. Hence, in Example 2, it can be considered that dispersion of the colorant in the polymerizable monomer was performed comparably well as Example 1 due to the use of the media particle having the same media diameter as that of Example 1. On the other hand, the number of continuously processed batches was less than Example 1 due to the use of a screen for media separation having a smaller aperture ratio than that of Example 1. However, circulation of more than 10 times without choking was possible so that it can be considered that a screen for media separation having the suitable aperture ratio corresponding to the used media particle could be chosen. Also, it was found that the polymerized toner obtained in Example 2 was a polymerized toner in which a colorant was finely and uniformly dispersed in the polymerizable monomer and also a polymerized toner with excellent fineness.

In Example 3, the media particle having a media diameter of 0.3 mm and the screen for media separation having a value of “aperture ratio/media diameter” of 120 were used. The measured viscosity of the polymerizable monomer dispersion after the first batch dispersion process resulted in 344 cP, which was lower than that of Example 1. On the other hand, the number of continuously processed batches was 20 or more and it was larger than that of Example 1. Printing density of the polymerized toner was 1.38 mg/cm² and it was lower than that of Example 1. Hence, in Example 3, it can be considered that pacing of dispersion of the colorant in the polymerizable monomer was slower than Example 1 due to the use of the media particle having a larger media diameter than that of Example 1. On the other hand, as for the number of continuously processed batches, continuous circulation of 10 times or more without choking was possible so that it can be considered that a screen for media separation having the suitable aperture ratio corresponding to the used media particle was able to be chosen. Also, it was found that the polymerized toner obtained in Example 3 was a polymerized toner in which the colorant was finely and uniformly dispersed in the polymerizable monomer and also a polymerized toner with excellent fineness.

In Example 4, the media particle having a media diameter of 0.3 mm and the screen for media separation having a value of “aperture ratio/media diameter” of 70 were used. The measured viscosity of the polymerizable monomer dispersion after the first batch dispersion process resulted in 368 cP, which was lower than that of Example 1. The number of continuously processed batches was 12 and it was smaller than that of Example 3. Printing density of the polymerized toner was 1.37 mg/cm² and it was lower than that of Example 1. Hence, in Example 4, it can be considered that pacing of dispersion of the colorant in the polymerizable monomer was slower than Example 1 due to the use of the media particle having a larger media diameter than that of Example 1. The number of continuously processed batches was less than Example 3 due to the use of a screen for media separation having a smaller aperture ratio than that of Example 3. However, continuous circulation of 10 times or more without choking was possible so that it can be considered that a screen for media separation having the suitable aperture ratio corresponding to the used media particle was able to be chosen. Also, it was found that the polymerized toner obtained in Example 4 was a polymerized toner in which the colorant was finely and uniformly dispersed in the polymerizable monomer and also a polymerized toner with excellent fineness.

In Comparative example 1, the media particle having a media diameter of 0.1 mm and the screen for media separation having a value of “aperture ratio/media diameter” of 429 were used. The measured viscosity of the polymerizable monomer dispersion after the first batch dispersion process resulted in 899 cP, which was a high value and close to that of Example 1. On the other hand, as for the number of continuously processed batches, it was evaluated that only one batch was able to operate since the screen for media separation was broken and leakage of media particles was found during the second batch. Hence, in Comparative example 1, it can be considered that pacing of dispersion of a colorant in the polymerizable monomer was almost same as Example 1 due to the use of the media particle having the same media diameter as that of Example 1. On the other hand, the number of continuously processed batches resulted in only one batch. It can be considered that since the screen for media separation having an excessively large aperture ratio was selected to use in relation to the media diameter and metal wires of the screen was too thin with respect to the media diameter, the wires were broken so as to break the screen.

In Comparative example 2, the media particle having a media diameter of 0.1 mm and the screen for media separation having a value of “aperture ratio/media diameter” of 47 were used. The measured viscosity of the polymerizable monomer dispersion after the first batch dispersion process resulted in 1,059 cP, which was a high value and close to that of Example 1. On the other hand, the number of continuously processed batches was 3 and it was far smaller than that of Example 1. Hence, in Comparative example 2, it can be considered that pacing of dispersion of the colorant in the polymerizable monomer was almost same as Example 1 due to the use of the media particle having a larger media diameter than that of Example 1. On the other hand, the number of continuously processed batches resulted in only three batches. It can be considered that since the screen for media separation having an excessively large aperture ratio was selected to use in relation to the media diameter, choking was likely to occur.

In Comparative example 3, the media particle having a media diameter of 0.3 mm and the screen for media separation having a value of “aperture ratio/media diameter” of 267 were used. During the first batch of dispersion process, metal wires of the screen reached the limit of strength and broke so that dispersion was stopped. It can be considered that since the screen for media separation having an excessively large aperture ratio was selected to use in relation to the media diameter and metal wires of the screen was too thin with respect to the media diameter, the wires were broken so as to break the screen.

In Comparative example 4, the media particle having a media diameter of 0.3 mm and the screen for media separation having a value of “aperture ratio/media diameter” of 43 were used. The measured viscosity of the polymerizable monomer dispersion after the first batch dispersion process resulted in 423 cP, which was lower than that of Example 1. Also, the number of continuously processed batches was 6 and it was far smaller than that of Example 1. Hence, in Comparative example 4, it can be considered that pacing of dispersion of the colorant in the polymerizable monomer was slower than Example 1 due to the use of the media particle having a larger media diameter than that of Example 1. Further, the number of continuously processed batches resulted in six batches. It can be considered that since the screen for media separation having an excessively small aperture ratio was selected to use in relation to the media diameter, choking was likely to occur.

In Comparative example 5, the media particle having a media diameter of 0.5 mm and the screen for media separation having a value of “aperture ratio/media diameter” of 75 were used. The measured viscosity of the polymerizable monomer dispersion after the first batch dispersion process resulted in 320 cP, which was lower than that of Example 1. On the other hand, the number of continuously processed batches was 20 or more and it was larger than that of Example 1. However, printing density of the polymerized toner was 1.20 mg/cm², which was significantly lower than that of Example 1. Hence, in Comparative example 5, it can be considered that pacing of dispersion of the colorant in the polymerizable monomer was slower than Example 3 due to the use of the media particle having a larger media diameter than that of Example 1. On the other hand, as for the number of continuously processed batches, continuous circulation of 20 times or more without choking was possible. It can be considered that it was simply due to the use of the media particle having an overlarge particle diameter. Also, it was found that the polymerized toner obtained in Comparative example 5 was a polymerized toner with insufficient colorant dispersion in the polymerizable monomer and lack in fineness.

What is claimed is:

1. A method of producing a polymerized toner comprising the steps of:
(1) preparing a polymerizable monomer composition containing a polymerizable monomer and a colorant;
(2) forming a droplet of the polymerizable monomer composition by dispersing the polymerizable monomer composition in an aqueous dispersion medium; and
(3) forming a colored resin particle by polymerizing the droplet of the polymerizable monomer composition,
wherein the step (1) includes a dispersing process in which a polymerizable monomer mixture containing the polymerizable monomer and the colorant is supplied to a media type dispersing machine equipped with a media particle and a screen for media separation and the colorant is dispersed in the polymerizable monomer mixture to obtain a polymerizable monomer dispersion, and
wherein a media diameter of the media particle and an aperture ratio of the screen for media separation satisfy the following formulas 1 and 2:
$$\begin{matrix}Formula 1 \text{:} & \\ 0.01 mm \leq ( media diameter ) \leq 0.3 mm & \\ Formula 2 : & \\ 50 \leq \frac{( Aperture ratio )}{( Media diameter )} \leq 260 & \end{matrix}$$
wherein, in the Formula 2, the aperture ratio is a value expressed in percentage and the media diameter is a value expressed in millimeter.

2. A method of producing a polymerized toner according to claim 1, wherein the polymerizable monomer mixture is subject to preliminary dispersion and an obtained preliminarily-dispersed polymerizable monomer mixture is supplied to the media type dispersing machine in the step (1).

3. A method of producing a polymerized toner according to claim 2, wherein the polymerizable monomer mixture contains a colorant having a volume average particle diameter of 20 μm or more and/or a colorant which has a volume percentage (D₅₁) of a particle having a particle diameter of 51 μm or more by 20% or more.

4. A method of producing a polymerized toner according to claim 2, wherein after the polymerizable monomer mixture comprising the polymerizable monomer and the colorant is subject to preliminary dispersion and an obtained preliminarily-dispersed polymerizable monomer mixture is supplied to the media type dispersing machine for dispersion, other components required for the toner are added to the obtained polymerizable monomer dispersion in the step (1).

5. A method of producing a polymerized toner according to claim 2, wherein a method of the preliminary dispersion is a method using a preliminary dispersing machine beside the method using the media type dispersing machine equipped with the screen for media separation.

6. A method of producing a polymerized toner according to claim 5, wherein the preliminary dispersion is performed by applying mechanical shearing stress to the colorant in the polymerizable monomer mixture.

7. A method of producing a polymerized toner according to claim 5, wherein a peripheral speed at the edge of a stirring vane of the preliminary dispersing machine is from 15 to 60 m/s.

8. A method of producing a polymerized toner according to claim 5, wherein an inner pressure of the preliminary dispersing machine is in the range of 0.01 to 15 MPa.

9. A method of producing a polymerized toner according to claim 2, wherein the preliminary dispersion is performed while holding a temperature variation range of the polymerizable monomer mixture before and after the preliminary dispersion preferably at 30° C. or less.

10. A method of producing a polymerized toner according to claim 2, wherein a volume average particle diameter of the colorant of the preliminarily-dispersed polymerizable monomer mixture is less than 20 μm and a volume percentage (D₅₁) of a particle having a particle diameter of 51 μm or more of the colorant of the preliminarily-dispersed polymerizable monomer mixture is less than 20%.

11. A method of producing a polymerized toner according to claim 1, wherein the polymerizable monomer mixture or a preliminarily-dispersed polymerizable monomer mixture obtained by preliminarily dispersing the polymerizable monomer mixture is supplied to the media type dispersing machine to disperse the colorant, discharged from the media type dispersing machine, supplied again to the media type dispersing machine, and continuously circulated at a circulation number of two or more in the process of dispersion in the process of dispersion.

12. A method of producing a polymerized toner according to claim 1, wherein a ratio of a volume of the media particle with respect to an inner volume of the media type dispersing machine where the media particle is present is from 60 to 95 volume percent.

13. A method of producing a polymerized toner according to claim 1, wherein a viscosity of a polymerizable monomer dispersion to be obtained by the process of dispersion is from 300 to 2,500 cP.

14. A method of producing a polymerized toner according to claim 1, wherein a colorant dispersing agent is added to the polymerizable monomer mixture in the step (1).

15. A method of producing a polymerized toner according to claim 14, wherein the colorant dispersing agent is selected from the group consisting of an Al coupling agent, a silane coupling agent and a titanate coupling agent.

16. A method of producing a polymerized toner according to claim 14, wherein the polymerizable monomer mixture with the colorant dispersing agent added is subject to preliminary dispersion and an obtained preliminarily-dispersed polymerizable monomer mixture is supplied to the media type dispersing machine in the step (1).

17. A method of producing a polymerized toner according to claim 1, wherein the liquid temperature of the polymerizable monomer mixture or the polymerizable monomer dispersion is in the range of 10 to 30° C. in the step (1).

18. A method of producing a polymerized toner according to claim 1, wherein a media diameter of the media particle is 0.01 mm or more and 0.1 mm or less in the dispersion process.

19. A method of producing a polymerized toner according to claim 1, wherein the screen for media separation is a notch wire type or a wedge wire type cylindrical screen.

20. A method of producing a polymerized toner according to claim 1, wherein a rotor and a casing of the media type dispersing machine, which contacts with the polymerizable monomer mixture or the polymerizable monomer dispersion, is made of a material having Rockwell Hardness C-Scale (HRC) of 20 or more.
